(19) United States
(12) Patent Application Publication
(10) Pub. No.: US 2025/0293843 A1
(43) Pub. Date: Sep. 18, 2025

(54) SPATIAL RELATION INDICATION

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 19/066,065

(22) Filed: Feb. 27, 2025

Related U.S. Application Data
(60) Provisional application No. 63/564,388, filed on Mar. 12, 2024.
(60) Provisional application No. 63/571,983, filed on Mar. 29, 2024.
(60) Provisional application No. 63/687,131, filed on Aug. 26, 2024.

(51) Int. Cl. H04L 5/00; H04L 27/26

(52) U.S. Cl. CPC H04L 5/0092; H04L 27/261

(57) ABSTRACT

Methods and apparatuses for spatial relation indications. A method of operating a user equipment (UE) includes receiving configuration information for transmission configuration indicator (TCI) states, receiving a first message activating K TCI state code points, from the configured TCI states, and receiving a first part of a second message signaling a quantity (N) of indicated TCI state code points from the K activated TCI state code points. The method further includes determining a size of a second part of the second message based on the first part of the second message and receiving the second part of the second message. The second part of the second message includes the N indicated TCI state code points.

### CROSS-REFERENCE TO RELATED AND CLAIM OF PRIORITY

The present application claims priority under 35 U.S.C. § 119(e) to U.S. Provisional Patent Application No. 63/564,388 filed on Mar. 12, 2024; U.S. Provisional Patent Application No. 63/571,983 filed on Mar. 29, 2024; and U.S. Provisional Patent Application No. 63/687,131 filed on Aug. 26, 2024, which are hereby incorporated by reference in their entirety.

### TECHNICAL FIELD

The present disclosure relates generally to wireless communication systems and, more specifically, the present disclosure relates to methods and apparatuses for a spatial relation indication.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to spatial relation indications.

In one embodiment, a user equipment (UE) is provided. The UE includes a transceiver configured to receive configuration information for transmission configuration indicator (TCI) states, receive a first message activating K TCI state code points, from the TCI states, where K≥1, and receive a first part of a second message signaling a quantity (N) of indicated TCI state code points from the K activated TCI state code points, where N≥1. The UE further includes a processor operably coupled to the transceiver. The processor is configured to determine a size of a second part of the second message based on the first part of the second message. The transceiver is further configured to receive the second part of the second message. The second part of the second message includes the N indicated TCI state code points.

In another embodiment, a base station is provided. The base station includes a transceiver configured to transmit configuration information for TCI states and transmit a first message activating K TCI state code points, from the TCI states, where K≥1. The base station a processor operably coupled to the transceiver. The processor configured to determine N of TCI state code points to indicate from the K activated TCI state code points, where N≥1. The transceiver is further configured to transmit a first part of a second message signaling the quantity N, transmit a second part of the second message. The second part of the second message includes the N indicated TCI state code points.

In yet another embodiment, a method of operating a UE is provided. The method includes receiving configuration information for TCI states; receiving a first message activating K TCI state code points, from the configured TCI states, where K≥1; receiving a first part of a second message signaling N indicated TCI state code points from the K activated TCI state code points, where N≥1; determining a size of a second part of the second message based on the first part of the second message; and receiving the second part of the second message. The second part of the second message includes the N indicated TCI state code points.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A, 7B, 7C, 7D, and 7E illustrate diagrams of example transmission configuration indication (TCI) state configurations according to embodiments of the present disclosure;

FIGS. 8A, 8B, 8C, 8D, 8E, and 8F illustrate diagrams of example TCI state configurations according to embodiments of the present disclosure;

FIG. 9 illustrates a diagram of an example TCI state configuration according to embodiments of the present disclosure;

FIG. 10 illustrates a diagram of an example information element configuration according to embodiments of the present disclosure;

FIG. 11 illustrates a diagram of an example information element configuration according to embodiments of the present disclosure;

FIG. 12 illustrates a diagram of an example information element configuration according to embodiments of the present disclosure;

FIG. 13 illustrates a diagram of an example higher layer control information configuration according to embodiments of the present disclosure;

FIG. 14 illustrates a diagram of an example dynamic control information configuration according to embodiments of the present disclosure;

FIG. 15 illustrates a diagram of an example dynamic control information configuration according to embodiments of the present disclosure;

FIG. 16 illustrates a diagram of an example medium access control (MAC) control element (CE) configuration according to embodiments of the present disclosure;

FIG. 17 illustrates a diagram of an example MAC CE configuration according to embodiments of the present disclosure;

FIG. 18 illustrates a diagram of an example MAC CE configuration according to embodiments of the present disclosure;

FIG. 19 illustrates a diagram of an example MAC CE configuration according to embodiments of the present disclosure;

FIG. 20 illustrates a diagram of an example two-stage dynamic control information configuration according to embodiments of the present disclosure;

FIG. 21 illustrates a diagram of an example two-stage dynamic control information configuration according to embodiments of the present disclosure;

FIG. 22 illustrates a diagram of an example two-stage dynamic control information configuration according to embodiments of the present disclosure;

FIG. 23 illustrates a diagram of example higher layer signaling according to embodiments of the present disclosure;

FIG. 24 illustrates a diagram of an example indicator according to embodiments of the present disclosure;

FIG. 25 illustrates a diagram of an example indicator according to embodiments of the present disclosure;

FIG. 26 illustrates a diagram of example events for activating subset B according to embodiments of the present disclosure;

FIG. 27 illustrates a diagram of an example indicator according to embodiments of the present disclosure;

FIG. 28 illustrates a diagram of an example indicator according to embodiments of the present disclosure;

FIG. 29 illustrates a diagram of example events for applying S3 according to embodiments of the present disclosure;

FIG. 30 illustrates a diagram of an example indicator according to embodiments of the present disclosure;

FIG. 31 illustrates a diagram of example events for activating subset S2 and applying S3 according to embodiments of the present disclosure;

FIG. 32 illustrates a diagram of example events for activating subset S2 and applying S3 according to embodiments of the present disclosure; and

FIG. 33 illustrates an example method performed by a UE in a wireless communication system according to embodiments of the present disclosure.

### DETAILED DESCRIPTION

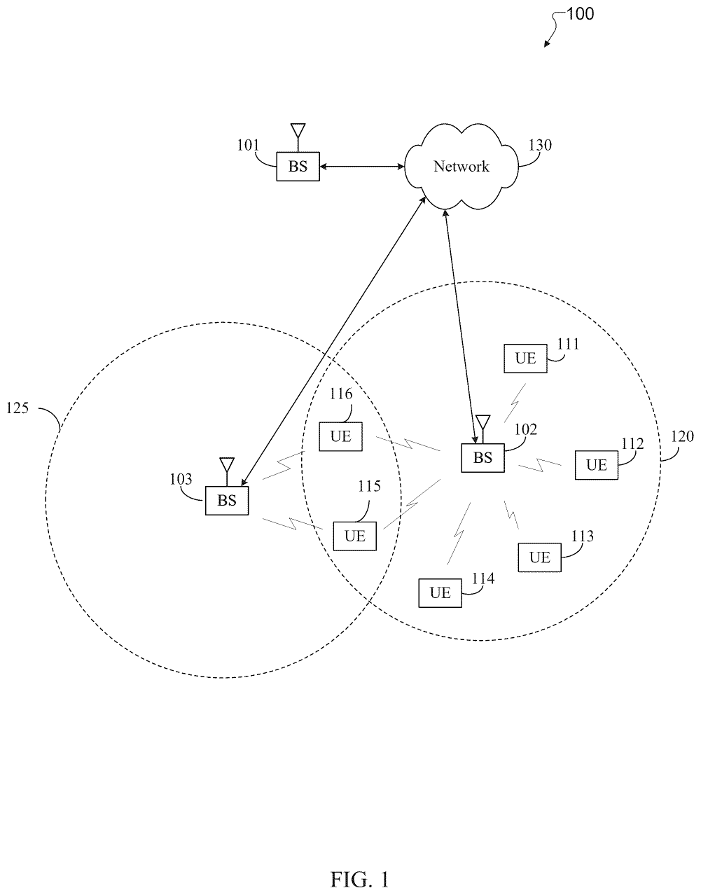

FIGS. 1-33, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and Channel coding;” [REF3] 3GPP TS 38.213 v18.1.0, “NR; Physical Layer Procedures for Control;” [REF4] 3GPP TS 38.214 v18.1.0, “NR; Physical Layer Procedures for Data;” [REF5] 3GPP TS 38.321 v18.0.0, “NR; Medium Access Control (MAC) protocol specification;” and [REF6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying, signaling, and/or applying spatial relation indications. In certain embodiments, one or more of the BSs 101-103 include circuitry, programing, or a combination thereof to support spatial relation indications.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

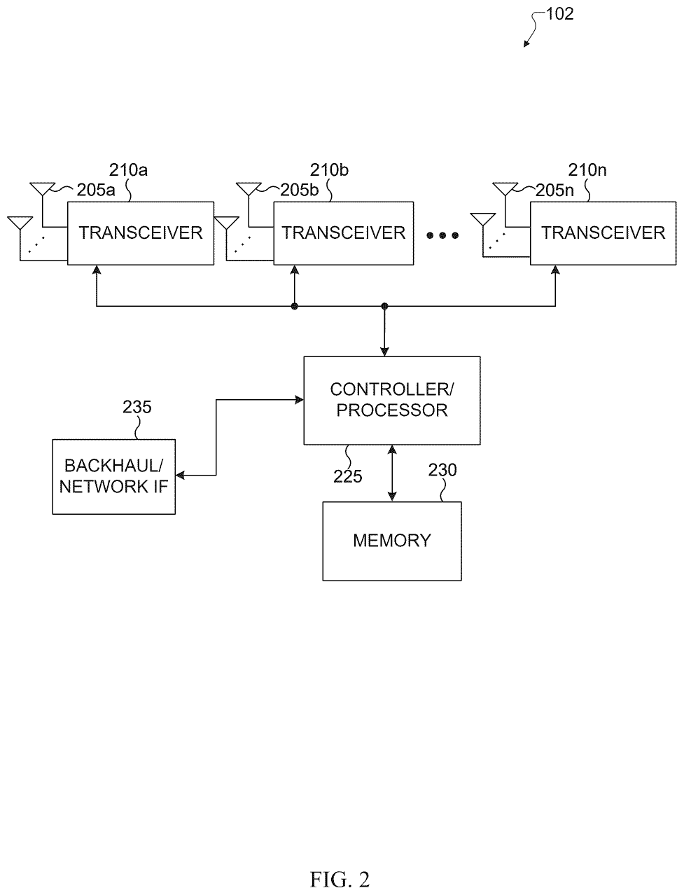

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting spatial relation indications. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

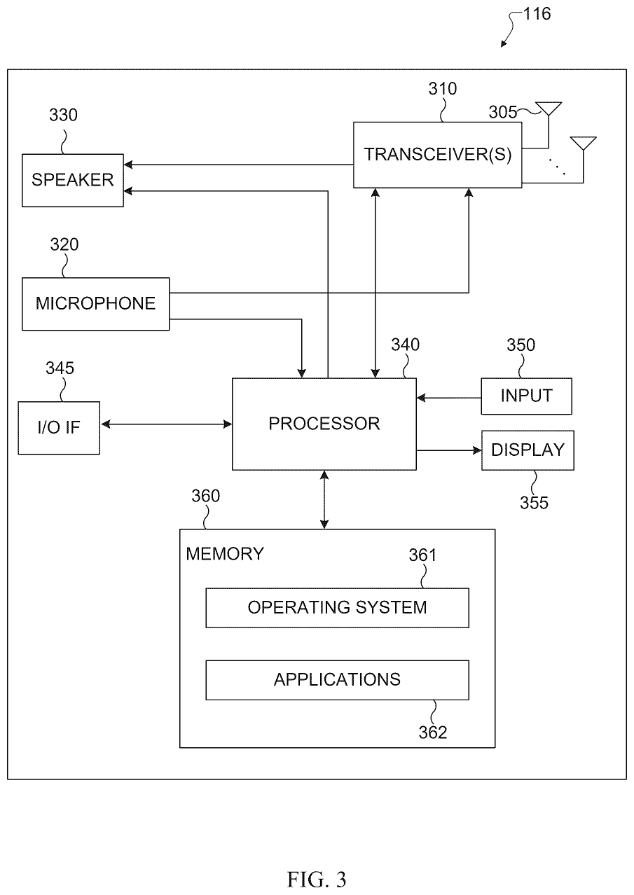

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify spatial relation indications as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

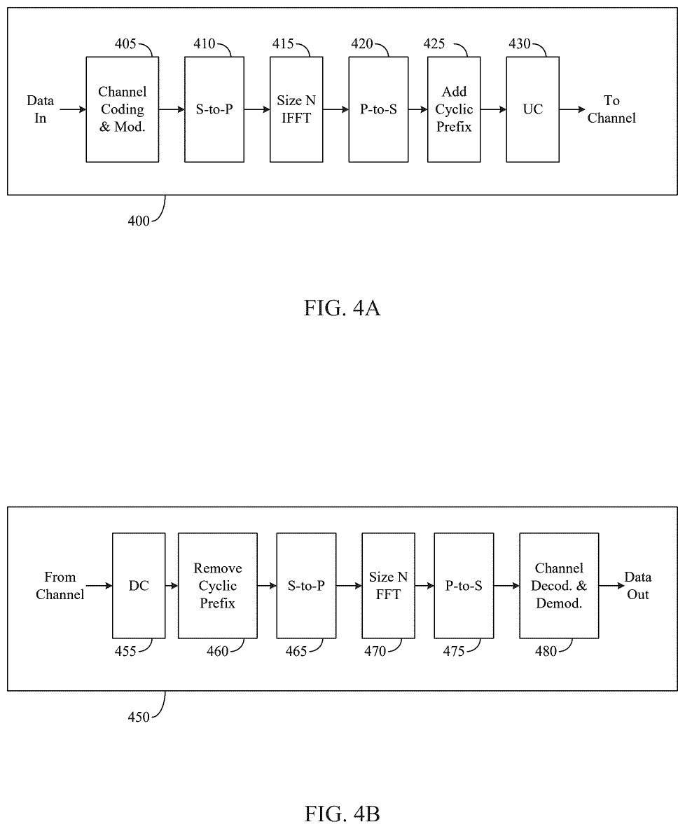

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support spatial relation indications as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

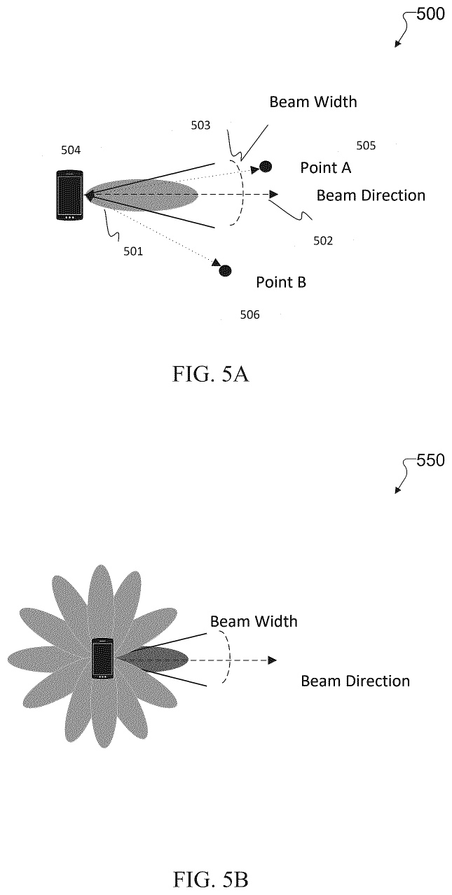

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

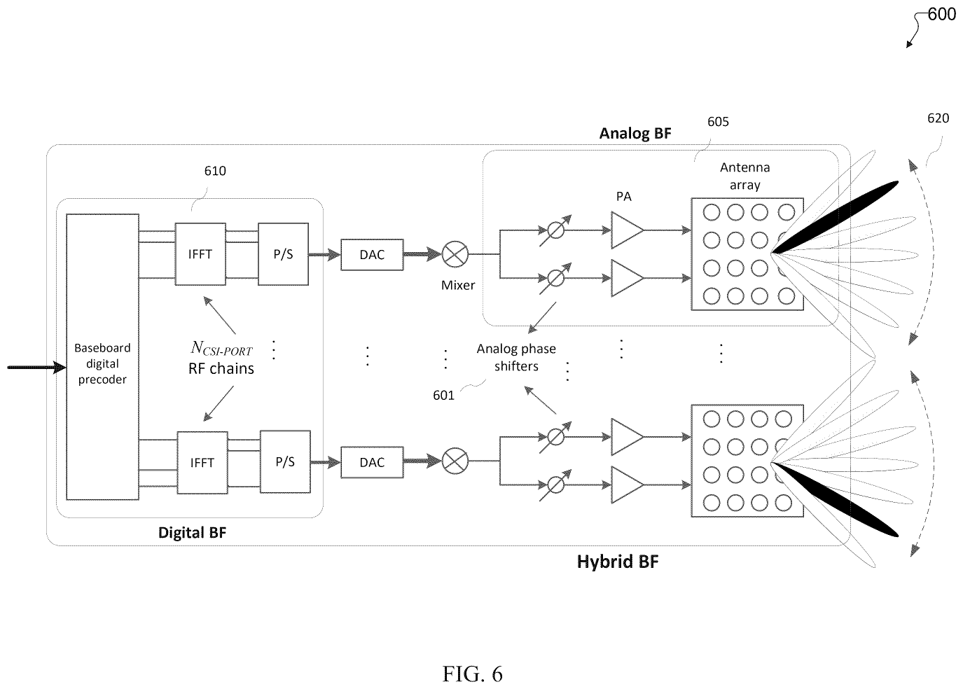

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

In this disclosure, [DEF1] a beam can be determined by any of.
A TCI state, that establishes a quasi-colocation (QCL) relationship or spatial relation between a source reference signal (e.g. synchronization signal block (SSB) and/or CSI-RS) and a target reference signal
A spatial relation information that establishes an association to a source reference signal, such as SSB or CSI-RS or sounding reference signal (SRS).

Alternatively, [DEF2] a beam can be determined by any of.
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or TCI state or spatial relation or the one (or two) port(s) identifies the beam.

Alternatively, [DEF3] a beam can be determined by a pair [A, B], which is any of
[A, B]=[TCI state, port]
[A, B]=[TCI state, PG]
[A, B]=[Spatial relation information, port]
[A, B]=[Spatial relation information, PG]
   Where TCI state, Spatial relation information, port and PG are as described herein. In this case, a pair of IDs for [A, B] identifies the beam.

According to [DEF1], the TCI state and/or the spatial relation reference RS can determine a spatial Rx filter or quasi-co-location information for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Likewise, for [DEF2], the port with dynamic virtualization and/or the PG with dynamic indication of one (or two) ports can determine a spatial Rx filter or quasi-co-location information or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB. In one example, a port can be associated with or indicated by a TCI state.

Likewise, for [DEF3], A and B together can determine a spatial Rx filter or quasi-co-location information for reception of downlink channels at the UE, or a spatial Tx filter for transmission of uplink channels from the UE. They can also determine a spatial Tx filter for transmission of downlink channels from the gNB, or a spatial Rx filter for reception of uplink channels at the gNB.

Rel-17 introduced the unified TCI framework, where a unified or main or indicated TCI state is signaled to the UE. The unified or main or indicated TCI state can be one of.
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE (e.g., the UE 116) is indicated a TCI state by MAC CE when the MAC CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose design channel or DCI Format for TCI state indication is applied after a beam application time from the corresponding HARQ-ACK feedback.

In this disclosure, aspects related to antenna port indication and beam indication are provided. An antenna port or a beam can be indicated by a TCI state ID, a TCI state ID can be for example, an antenna port ID. In one example, an antenna port or TCI state represents indication for a channel with one-input and one-output. In one example, a pair of an antenna port and TCI state represents indication for a channel with one-input and one-output.

Embodiments of the present disclosure recognize that in NR there are different levels of abstraction for beam indication and antenna port indication which adds unnecessary complexity to MIMO and beam indication. To simplify beam and/or antenna port indication, a spatial resource unit is regarded as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [TS 38.211]. A UE can be indicated with one or more spatial resource unit.

In this disclosure a spatial resource unit is provided as a reference signal (e.g., a reference signal with one antenna port) or an antenna port of a reference signal. A spatial resource unit is identified by an ID (e.g., spatial resource unit ID). A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID.

In this disclosure configuration of TCI state representing spatial resource units are provided. Indication or activation or configuration of common parameters across a set of multiple TCI states (e.g., multiple spatial resource units) is provided. Finally, indication of TCI state(s) (e.g., spatial resource unit(s)) is provided, where a UE can be indicated one or more TCI state(s) (e.g., spatial resource unit(s)). In some embodiments, the indicated TCI state (e.g., spatial resource unit) can indicate a port ID. In some embodiments for example for network (e.g., the network 130) energy savings, the indicated TCI state(s) (e.g., spatial resource unit(s) or antenna port(s)) are a subset of those activated or configured, this can be for example for network energy saving purposes. In some embodiments for example for operation in FR2, multiple TCI states are configured or activated, a UE is indicated a subset of these TCI states (e.g., a subset of spatial resource units) depending on the channel propagation conditions. The indicated TCI state (e.g., spatial resource unit) can correspond to a beam or an antenna port or a beam-antenna port pair.

The present disclosure relates to a NR/5G and/or 6G communication system.

This disclosure provides aspects related to multi-variate TCI state configuration and signaling:
Configuration of spatial resource unit(s) (e.g., TCI state representing a spatial resource unit).
Configuration activation or indication of common parameters across a set of spatial resource unit(s) (e.g., across a set of TCI state(s) representing spatial resource unit(s))
Indication of multi-variate spatial resource unit(s) (e.g., multi-variate TCI state(s)).

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple subframes or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-reference signal received power (RSRP)/L1-signal-to-interference-plus-noise ratio (SINR) accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB (e.g., the BS 102) can measure and calculate the needed information to assign a particular DL (or/and UL) TX beam to the UE, for example in case of channel reciprocity.

In one example of this disclosure, a reference signal can be configured with one antenna port.

In one example of this disclosure, a reference signal can be configured with N antenna ports.

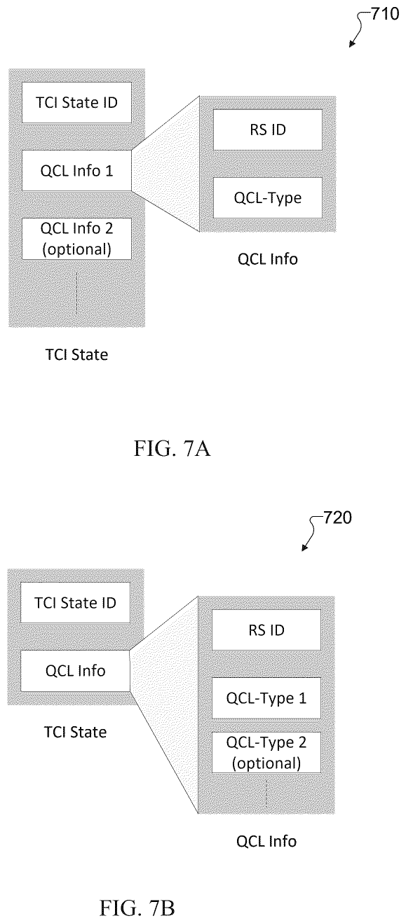

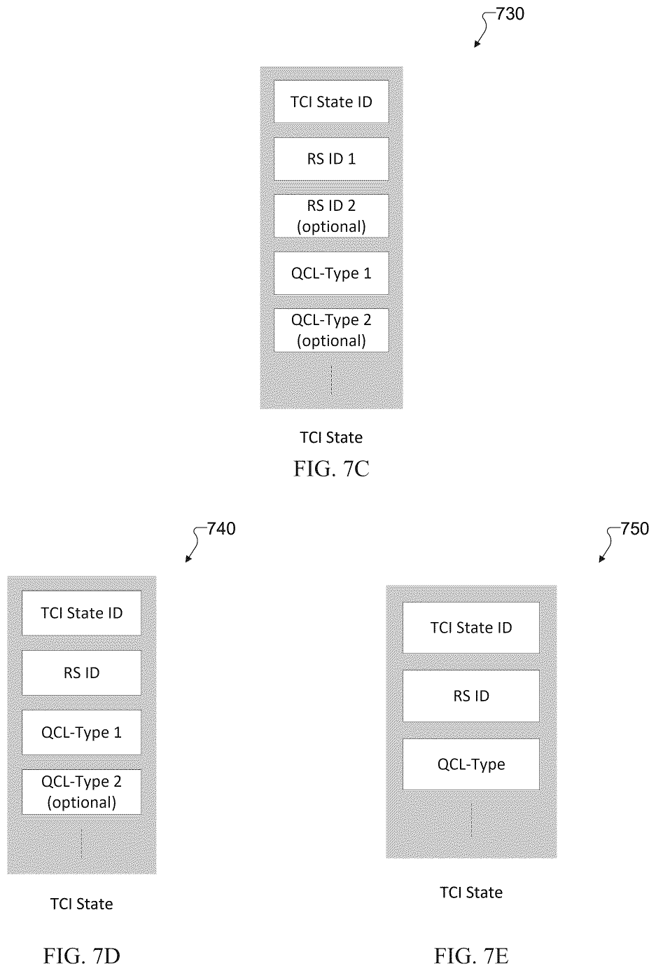

FIGS. 7A, 7B, 7C, 7D, and 7E illustrate diagrams of example TCI state configurations 710, 720, 730, 740, and 750, respectively, according to embodiments of the present disclosure. For example, TCI state configurations 710, 720, 730, 740, and 750, respectively, can be utilized by any of the UEs 111-116 of FIG. 1. This example is for illustration only and other embodiments can be used without departing from the scope of the present disclosure. This example is for illustration only and other embodiments can be used without departing from the scope of the present disclosure.

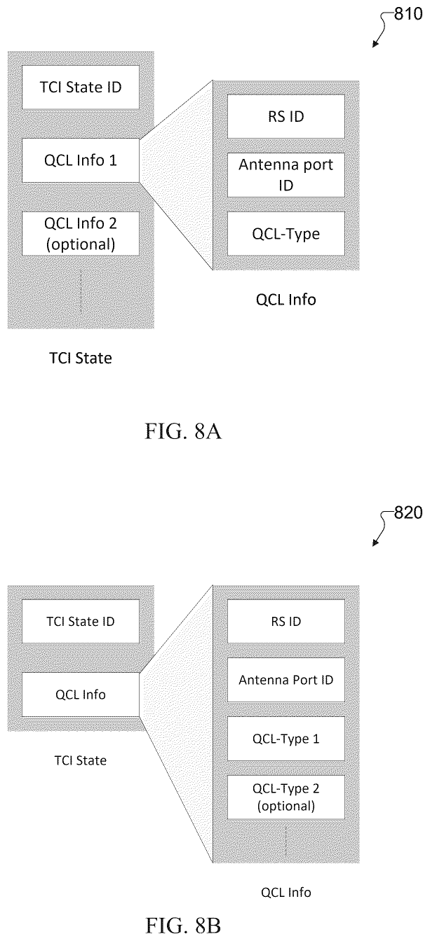

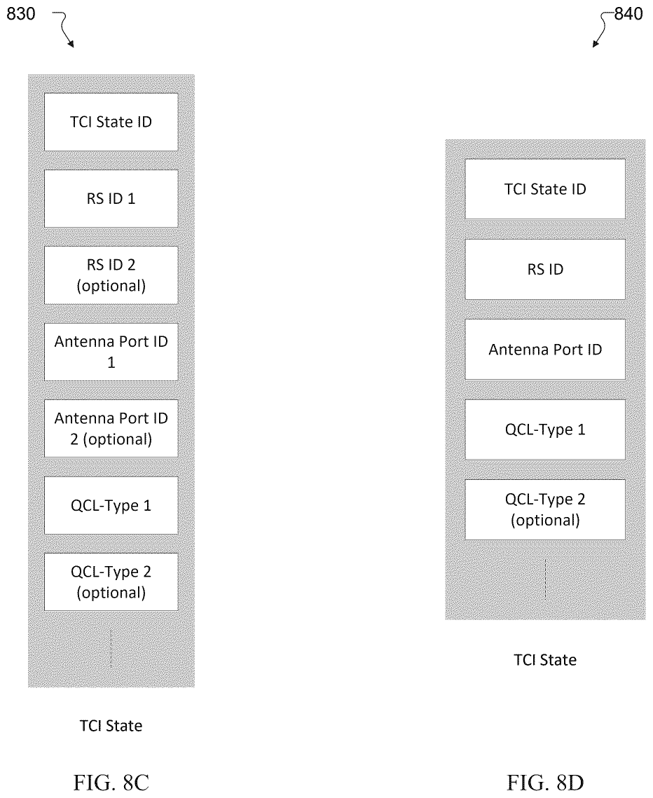

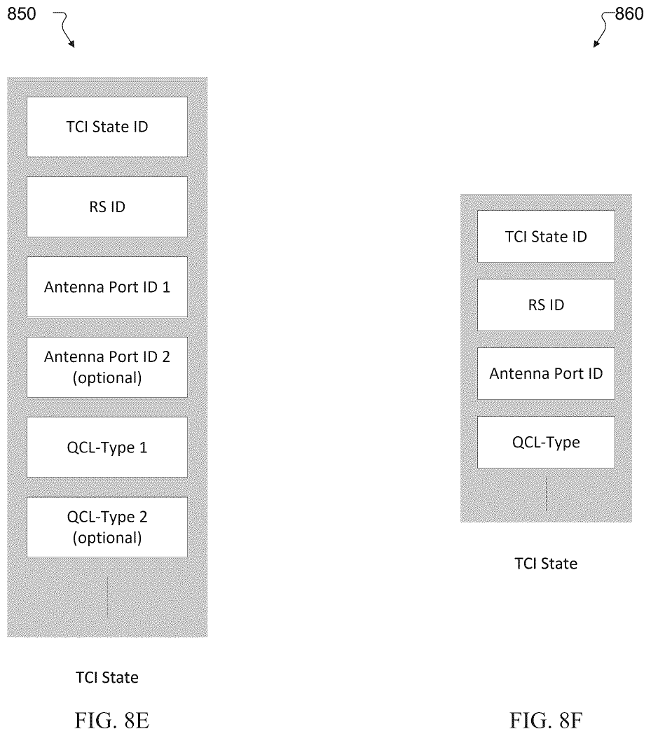

FIGS. 8A, 8B, 8C, 8D, 8E, and 8F illustrate diagrams of example TCI state configurations 810, 820, 830, 840, 850, and 860, respectively, according to embodiments of the present disclosure. For example, TCI state configurations 810, 820, 830, 840, 850, and 860, respectively, can be utilized by any of the UEs 111-116 of FIG. 1, such as the UE 111.

In one example, an entity for spatial domain (or spatial relation) indication (e.g., a spatial domain resource unit) is a TCI state. Wherein, a TCI state can include:
A TCI state ID
One or more QCL information elements. Wherein, a QCL information element can include
   Reference signal ID (e.g., reference signal configured with one antenna port)
   One or more QCL Types. (e.g., QCL Type-A or Type-B or Type-C, and/or QCL Type-D)

With reference to FIG. 7A, one example of a TCI state is shown, wherein the TCI state includes a TCI state ID, a first QCL info field and a second QCL info field. Other information element fields are not precluded from being included in the TCI state. A QCL Info field includes a reference signal ID and a QCL Type e.g., QCL-TypeA or QCL-TypeB or QCL-TypeC or QCL-TypeD. Other information element fields are not precluded from being included in QCL Info.

With reference to FIG. 7B, one example of a TCI state is shown, wherein the TCI state includes a TCI state ID and a QCL info field. Other information element fields are not precluded from being included in the TCI state. A QCL Info field includes a reference signal ID and a first QCL Type e.g., QCL-TypeA or QCL-TypeB or QCL-TypeC and a second QCL Type e.g., TypeD. Other information element fields are not precluded from being included in QCL Info.

With reference to FIG. 7C, one example of a TCI state is shown, wherein the TCI state includes a TCI state ID, a first reference signal (RS) ID, a second RS ID, a first QCL Type e.g., QCL-TypeA or QCL-TypeB or QCL-TypeC and a second QCL Type e.g., TypeD. In one example, the first RS ID is associated with the first QCL Type and the second RS ID is associated with the second QCL Type. Other information element fields are not precluded from being included in the TCI state.

With reference to FIG. 7D, one example of a TCI state is shown, wherein the TCI state includes a TCI state ID, a reference signal (RS) ID, a first QCL Type e.g., QCL-TypeA or QCL-TypeB or QCL-TypeC and a second QCL Type e.g., TypeD. The RS provided by the RS ID is associated with the first QCL Type and the second QCL Type. Other information element fields are not precluded from being included in the TCI state.

With reference to FIG. 7E, one example of a TCI state is shown, wherein the TCI state includes a TCI state ID, a reference signal (RS) ID and a QCL Type e.g., QCL-TypeA or QCL-TypeB or QCL-TypeC or TypeD. Other information element fields are not precluded from being included in the TCI state.

In one example, an entity for spatial domain (or spatial relation) indication is a TCI state. Wherein, a TCI state can include:
A TCI state ID
One or more QCL information elements. Wherein, a QCL information element can include
   Reference signal ID
   Antenna port
   One or more QCL Types. (e.g., QCL Type-A or Type-B or Type-C, and/or QCL Type-D)

With reference to FIG. 8A, one example of a TCI state is shown, wherein the TCI state includes a TCI state ID, a first QCL info field and a second QCL info field. Other information element fields are not precluded from being included in the TCI state. A QCL Info field includes a reference signal ID, a corresponding antenna port ID or antenna port index and a QCL Type e.g., QCL-TypeA or QCL-TypeB or QCL-TypeC or QCL-TypeD. Other information element fields are not precluded from being included in QCL Info.

With reference to FIG. 8B, one example of a TCI state is shown, wherein the TCI state includes a TCI state ID and a QCL info field. Other information element fields are not precluded from being included in the TCI state. A QCL Info field includes a reference signal ID, a corresponding antenna port ID or antenna port index and a first QCL Type e.g., QCL-TypeA or QCL-TypeB or QCL-TypeC and a second QCL Type e.g., TypeD. Other information element fields are not precluded from being included in QCL Info.

With reference to FIG. 8C, one example of a TCI state is shown, wherein the TCI state includes a TCI state ID, a first reference signal (RS) ID, a second RS ID, a first antenna port ID or antenna port index, a second antenna port ID or antenna port index, a first QCL Type e.g., QCL-TypeA or QCL-TypeB or QCL-TypeC a second QCL Type e.g., TypeD. In one example, the first RS ID is associated with the first antenna port ID or antenna port index and the second RS ID is associated with the second antenna port ID or antenna port index. In one example, the first RS ID is associated with the first QCL Type and the second RS ID is associated with the second QCL Type. Other information element fields are not precluded from being included in the TCI state.

With reference to FIG. 8D, one example of a TCI state is shown, wherein the TCI state includes a TCI state ID, a reference signal (RS) ID, a corresponding antenna port ID or antenna port index, a first QCL Type e.g., QCL-TypeA or QCL-TypeB or QCL-TypeC a second QCL Type e.g., TypeD. In one example, the RS corresponding to the RS ID and the antenna port corresponding to the antenna port ID are associated with the first QCL Type and the second QCL Type. Other information element fields are not precluded from being included in the TCI state.

With reference to FIG. 8E, one example of a TCI state is shown, wherein the TCI state includes a TCI state ID, a reference signal (RS) ID, a corresponding first antenna port ID or antenna port index, a corresponding second antenna port ID or antenna port index, a first QCL Type e.g., QCL-TypeA or QCL-TypeB or QCL-TypeC a second QCL Type e.g., TypeD. In one example, the first antenna port ID or antenna port index is associated with the first QCL Type and the second antenna port ID or antenna port index is associated with the second QCL Type. Other information element fields are not precluded from being included in the TCI state.

With reference to FIG. 8F, one example of a TCI state is shown, wherein the TCI state includes a TCI state ID, a reference signal (RS) ID, a corresponding antenna port ID or antenna port index and a QCL Type e.g., QCL-TypeA or QCL-TypeB or QCL-TypeC or TypeD. Other information element fields are not precluded from being included in the TCI state.

In one example, a parameter is associated with N TCI states where N≥1. In one example, the parameter can be:
Pathloss reference signal or path reference signal index.
Power control parameter, e.g., parameter PO, and/or parameter alpha and/or closed-loop power index. In one example the power control parameters are included in a set, and index to the set is provided.
TAG ID or TAG ID pointer.

Let's denote the parameters that can be common across multiple TCI states as parameter C0, parameter C1, etc.

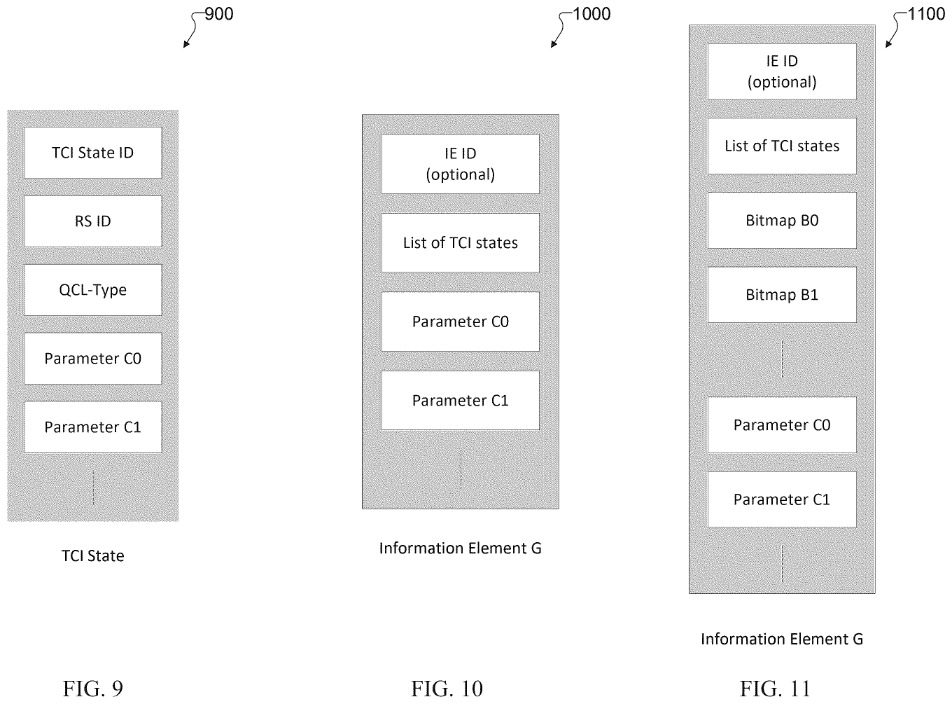

FIG. 9 illustrates a diagram of an example TCI state configuration 900 according to embodiments of the present disclosure. For example, TCI state configuration 900 can be utilized by the UE 116 of FIG. 3. This example is for illustration only and other embodiments can be used without departing from the scope of the present disclosure.

In one example, parameter C0, parameter C1, etc., is included in each TCI as illustrated FIG. 9, which is based on the TCI state of FIG. 7E, however, this can be applied to any TCI state definition mentioned herein, e.g., as defined in FIG. 7A-FIG. 7E, or FIG. 8A-FIG. 8F.

With reference to FIG. 9 one example of a TCI state is shown, wherein the TCI state includes a TCI state ID, a reference signal (RS) ID, a QCL Type e.g., QCL-TypeA or QCL-TypeB or QCL-TypeC or TypeD, parameter C0 and parameter C1. Other information element fields are not precluded from being included in the TCI state.

FIG. 10 illustrates a diagram of an example information element configuration 1000 according to embodiments of the present disclosure. For example, information element configuration 1000 can be utilized by any of the UEs 111-116 of FIG. 1. This example is for illustration only and other embodiments can be used without departing from the scope of the present disclosure.

FIG. 11 illustrates a diagram of an example information element configuration 1100 according to embodiments of the present disclosure. For example, information element configuration 1100 can be utilized by any of the UEs 111-116 of FIG. 1, such as the UE 112. This example is for illustration only and other embodiments can be used without departing from the scope of the present disclosure.

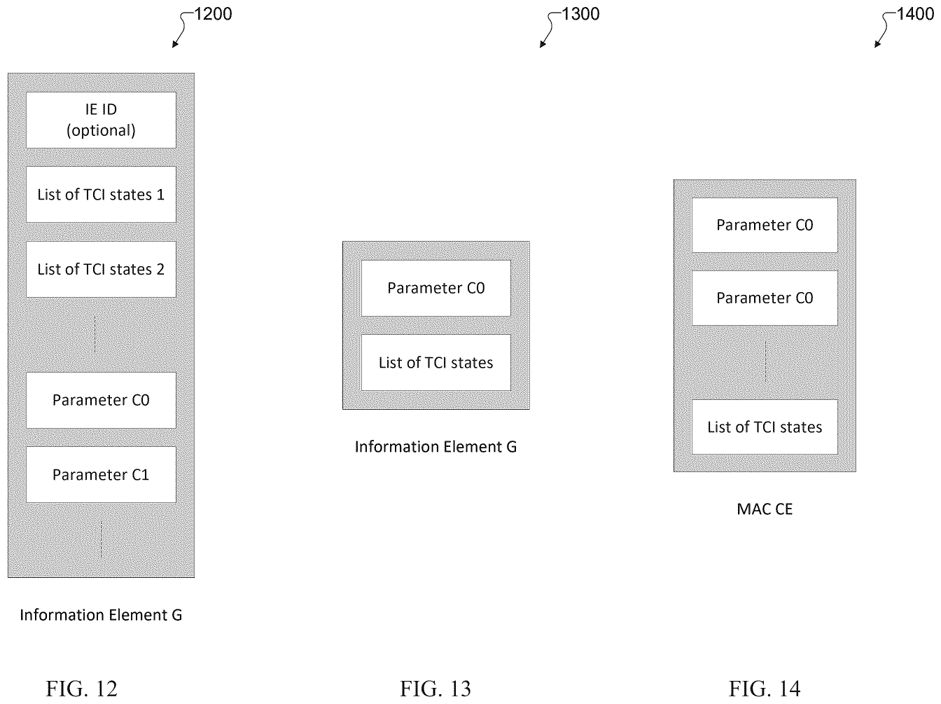

FIG. 12 illustrates a diagram of an example information element configuration 1200 according to embodiments of the present disclosure. For example, information element configuration 1200 can be utilized by any of the UEs 111-116 of FIG. 1, such as the UE 113. This example is for illustration only and other embodiments can be used without departing from the scope of the present disclosure.

FIG. 13 illustrates a diagram of an example higher layer control information configuration 1300 according to embodiments of the present disclosure. For example, higher layer control information configuration 1300 can be utilized by any of the UEs 111-116 of FIG. 1, such as the UE 114. This example is for illustration only and other embodiments can be used without departing from the scope of the present disclosure.

FIG. 14 illustrates a diagram of an example dynamic control information configuration 1400 according to embodiments of the present disclosure. For example, dynamic control information configuration 1400 can be utilized by any of the UEs 111-116 of FIG. 1, such as the UE 115. This example is for illustration only and other embodiments can be used without departing from the scope of the present disclosure.

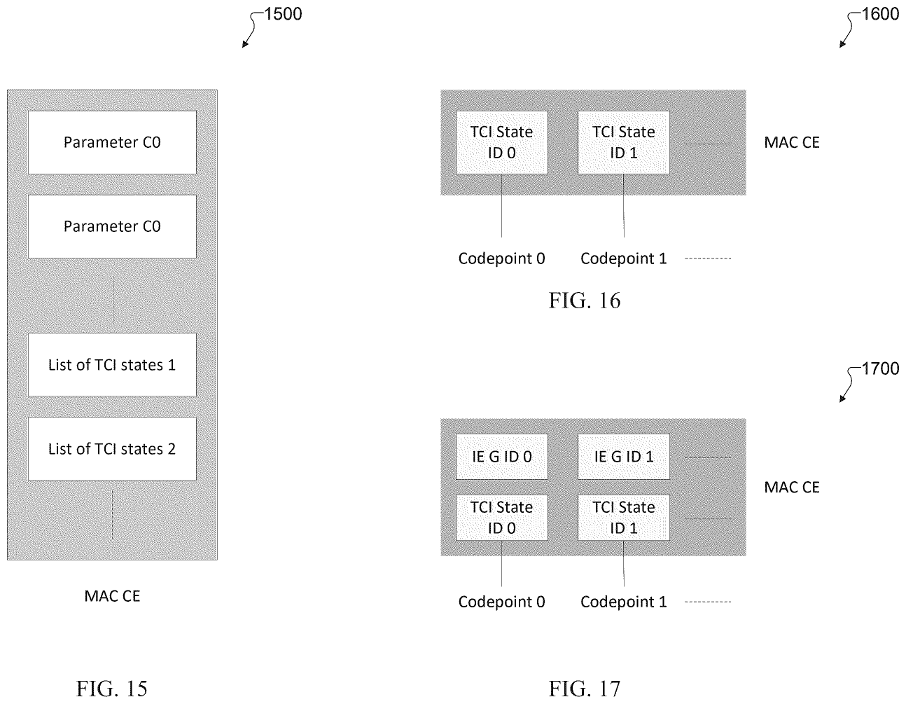

FIG. 15 illustrates a diagram of an example dynamic control information configuration 1500 according to embodiments of the present disclosure. For example, dynamic control information configuration 1500 can be utilized by the UE 116 of FIG. 3. This example is for illustration only and other embodiments can be used without departing from the scope of the present disclosure.

In one example, as illustrated in FIG. 10, an information element (e.g., G) is configured, where in the information element includes:
Optionally, information element ID
A list of TCI states
Parameter C0, parameter C0 applies to the list of TCI states
Optionally, Parameter C1, parameter C1 applies to the list of TCI states
. . .

Wherein, parameter C0, parameter C1, can be one of pathloss reference signal (PL-RS) ID, power control parameter set ID, TAG ID pointer, etc.

In one example, as illustrated in FIG. 11, an information element (e.g., G) is configured, where in the information element includes:
Optionally, information element ID
A list of TCI states
Bitmap B0 across the list of TCI with a bit in the bitmap corresponding to a TCI state in the list
Optionally, Bitmap B1 across the list of TCI with a bit in the bitmap corresponding to a TCI state in the list
Parameter C0, parameter C0 applies to TCI states in the list, where the corresponding bit in bitmap B0 is “1”
Optionally, Parameter C1, parameter C1 applies to TCI states in the list, where the corresponding bit in bitmap B1 is “1”
. . .

In one example, as illustrated in FIG. 12, an information element (e.g., G) is configured, where in the information element includes:
Optionally, information element ID
A first list of TCI states
Optionally, A second list of TCI states
Parameter C0, parameter C0 applies to the first list of TCI states.
Optionally, Parameter C1, parameter C1 applies to the second list of TCI states
. . .

In one example, as illustrated in FIG. 13, a higher layer control information (e.g., RRC) configures a common parameter e.g., C0 and a list of TCI states to which the common parameter C0 applies or a list of TCI states which applies the common parameter.

In one example, as illustrated in FIG. 14, a dynamic control information (e.g., MAC CE or L1 control) indicates or activates a common parameter a first common parameter C0 and a (optionally) second common parameter C1, etc. and a list of TCI states, to which the common parameters C0 and C1 . . . applies, a list of TCI states which applies the common parameters C0, C1, . . . .

In one example, as illustrated in FIG. 15, a dynamic control information (e.g., MAC CE or L1 control) indicates or activates a common parameter a first common parameter C0 and (optionally) a second common parameter C1, etc. and (1) a first list of TCI states, to which the common parameter C0 applies, or a first list of TCI states which applies the common parameter C0, (2) (optionally) a second list of TCI states, to which the common parameter C1 applies, or a second list of TCI states which applies the common parameter C1, . . . .

FIG. 16 illustrates a diagram of an example MAC CE (or DCI) configuration 1600 according to embodiments of the present disclosure. For example, MAC CE (or DCI) configuration 1600 can be utilized by any of the UEs 111-116 of FIG. 1, such as the UE 116. This example is for illustration only and other embodiments can be used without departing from the scope of the present disclosure.

FIG. 17 illustrates a diagram of an example MAC CE (or DCI) configuration 1700 according to embodiments of the present disclosure. For example, MAC CE (or DCI) configuration 1700 can be utilized by any of the UEs 111-116 of FIG. 1, such as the UE 111. This example is for illustration only and other embodiments can be used without departing from the scope of the present disclosure.

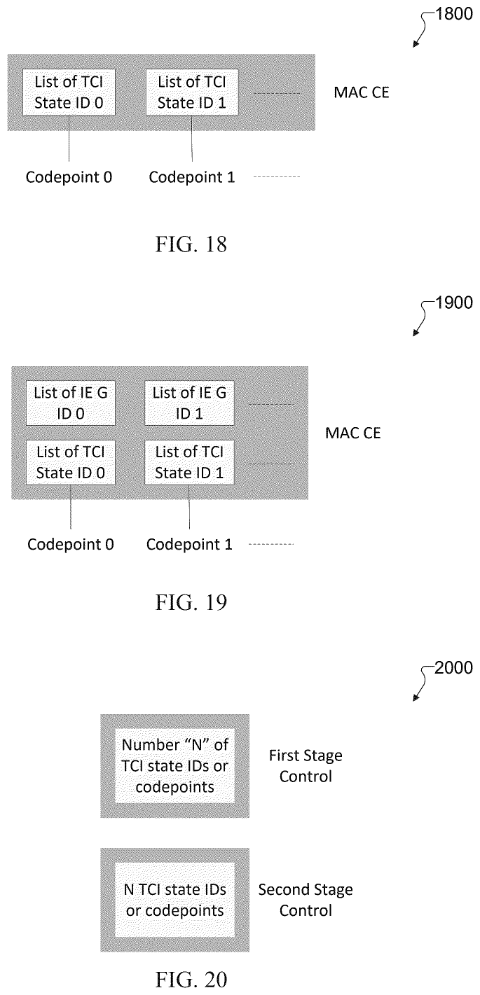

FIG. 18 illustrates a diagram of an example MAC CE (or DCI) configuration 1800 according to embodiments of the present disclosure. For example, MAC CE (or DCI) configuration 1800 can be utilized by any of the UEs 111-116 of FIG. 1, such as the UE 112. This example is for illustration only and other embodiments can be used without departing from the scope of the present disclosure.

FIG. 19 illustrates a diagram of an example MAC CE (or DCI) configuration 1900 according to embodiments of the present disclosure. For example, MAC CE (or DCI) configuration 1900 can be utilized by any of the UEs 111-116 of FIG. 1, such as the UE 113. This example is for illustration only and other embodiments can be used without departing from the scope of the present disclosure.

In one example, as illustrated in FIG. 16, a list of TCI states is activated (e.g., by dynamic control information (e.g., MAC CE or L1 control (e.g., DCI))). In one example, the activated list of TCI states includes a list of TCI state IDs. Associated with each TCI state ID is a TCI state codepoint. In one example, the codepoint is the ordinal position of the TCI state ID in the list.

In one example, as illustrated in FIG. 17, a list of TCI states is activated (e.g., by dynamic control information (e.g., MAC CE or L1 control (e.g., DCI))). In one example, the activated list of TCI states includes a list of information elements (e.g., G as mentioned herein) and a corresponding list of TCI state IDs. Associated with each TCI state ID is a TCI state codepoint. In one example, the codepoint is the ordinal position of the TCI state ID in the list.

In one example, as illustrated in FIG. 18, a list of TCI state codepoints is activated (e.g., by dynamic control information (e.g., MAC CE or L1 control (e.g., DCI))). In one example, each codepoint includes a list of one or more of TCI state IDs. The codepoint is determined by the ordinal position of the corresponding list of TCI states.

In one example, as illustrated in FIG. 19, a list of TCI state codepoints is activated (e.g., by dynamic control information (e.g., MAC CE or L1 control (e.g., DCI))). In one example, each codepoint includes a list of one or more information elements (e.g., G as mentioned herein) and a corresponding list of one or more of TCI state IDs. The codepoint is determined by the ordinal position of the corresponding list of TCI states.

In one example, TCI states or TCI state codepoints are activated by dynamic control signaling (e.g., MAC CE or L1 control (e.g., DCI)).

In one example, multiple TCI states or TCI state codepoints are indicated to a UE.

In one example a UE (e.g., the UE 116) is indicated (e.g., by dynamic control information (e.g., MAC CE or L1 control (e.g., DCI))) a codepoint of the activated TCI states. In one example, a code point corresponds to one TCI state. In one example, a codepoint corresponds to more than one (e.g. a list of TCI states).

In one example a UE is indicated (e.g., by dynamic control information (e.g., MAC CE or L1 control (e.g., DCI))) a bitmap that indicates one or more codepoints of the activated TCI states wherein each bit corresponds to a codepoint of the activated TCI states. In one example, if a bit in the bitmap corresponding to a codepoint is “1”, the codepoint is indicated to the UE, otherwise if a bit in the bitmap corresponding to a codepoint is “0”, the codepoint is not indicated to the UE. In one example, a codepoint corresponds to one TCI state. In one example, a codepoint corresponds to more than one (e.g. a list of) TCI states.

In one example a UE is indicated (e.g., by dynamic control information (e.g., MAC CE or L1 control (e.g., DCI))) a list of codepoints of the activated TCI states. In one example, a codepoint corresponds to one TCI state. In one example, a codepoint corresponds to more than one (e.g. a list of) TCI states.

In one example a UE is indicated (e.g., by dynamic control information (e.g., MAC CE or L1 control (e.g., DCI))) a TCI state of the activated TCI states.

In one example a UE is indicated (e.g., by dynamic control information (e.g., MAC CE or L1 control (e.g., DCI))) a list of TCI states of the activated TCI states.

In one example a UE is indicated (e.g., by dynamic control information (e.g., MAC CE or L1 control (e.g., DCI))) a bitmap that indicates one or more TCI states from the list of TCI states wherein each bit corresponds to an activated TCI state. In one example the TCI states are activated TCI states, an index in the activation command associated with a TCI state, or the ordinal position of a TCI state in the activation command can indicate the bit corresponding to the TCI state in the bitmap. In one example, if a bit in the bitmap corresponding to a TCI state is “1”, the TCI state is indicated to the UE, otherwise if a bit in the bitmap corresponding to a TCI state is “0”, the TCI state is not indicated to the UE.

In one example a UE is indicated (e.g., by dynamic control information (e.g., MAC CE or L1 control (e.g., DCI))) a TCI state of the higher layer configured TCI states (e.g., configured by RRC or SIB signaling).

In one example a UE is indicated (e.g., by dynamic control information (e.g., MAC CE or L1 control (e.g., DCI))) a list of TCI states of the higher layer configured TCI states (e.g., configured by RRC or SIB signaling).

In one example a UE is indicated (e.g., by dynamic control information (e.g., MAC CE or L1 control (e.g., DCI))) a bitmap that indicates one or more TCI states from the list of TCI states wherein each bit corresponds to a higher layer configured TCI state (e.g., configured by RRC or SIB signaling). In one example the TCI states are higher layer configured TCI states (e.g., configured by RRC or SIB signaling), an index in the configuration command associated with a TCI state, or the ordinal position of a TCI state in the configuration command can indicate the bit corresponding to the TCI state in the bitmap. In one example, if a bit in the bitmap corresponding to a TCI state is “1”, the TCI state is indicated to the UE, otherwise if a bit in the bitmap corresponding to a TCI state is “0”, the TCI state is not indicated to the UE.

In one example, dynamic control information is one-stage L1 control information.

In one example, dynamic control information is one-stage L1 control information. The L1 control information includes TCI state indication (beam indication) without scheduling information (e.g., UL grant or DL assignment). In one example, dynamic control information is one-stage L1 control information using a purposed design DCI Format for beam indication.

In one example, dynamic control information is one-stage L1 control information. The L1 control information includes TCI state indication (beam indication) with scheduling information (e.g., UL grant or DL assignment). In one example, the scheduling information is DL scheduling information. In one example, the scheduling information is UL scheduling information. In one example, the scheduling information is DL scheduling information and UL scheduling information.

FIG. 20 illustrates a diagram of an example two-stage dynamic control information configuration 2000 according to embodiments of the present disclosure. For example, two-stage dynamic control information configuration 2000 can be utilized by any of the UEs 111-116 of FIG. 1, such as the UE 114. This example is for illustration only and other embodiments can be used without departing from the scope of the present disclosure.

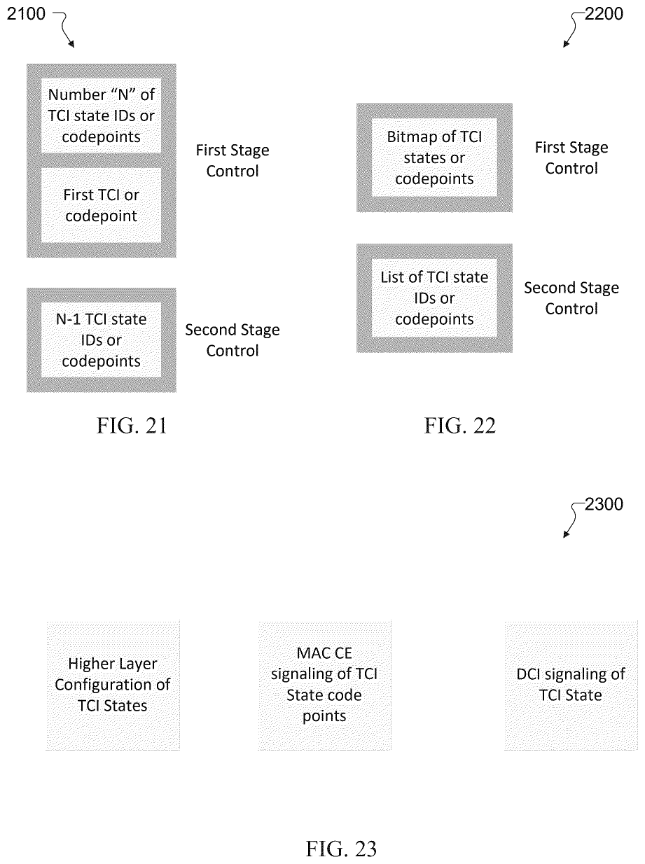

FIG. 21 illustrates a diagram of an example two-stage dynamic control information 2100 configuration according to embodiments of the present disclosure. For example, two-stage dynamic control information 2100 can be utilized by any of the UEs 111-116 of FIG. 1, such as the UE 115. This example is for illustration only and other embodiments can be used without departing from the scope of the present disclosure.

FIG. 22 illustrates a diagram of an example two-stage dynamic control information configuration 2200 according to embodiments of the present disclosure. For example, two-stage dynamic control information configuration 2200 can be utilized by the UE 116 of FIG. 3. This example is for illustration only and other embodiments can be used without departing from the scope of the present disclosure.

In one example, dynamic control information is two-stage L1 control information.

In one example, dynamic control information is two-stage L1 control information. The L1 control information includes TCI state indication (beam indication) without scheduling information (e.g., UL grant or DL assignment). In one example, dynamic control information is two-stage L1 control information using a purposed design two-stage DCI Format for beam indication.

In one example, dynamic control information is two-stage L1 control information. The L1 control information includes TCI state indication (beam indication) with scheduling information (e.g., UL grant or DL assignment). In one example, the scheduling information is DL scheduling information. In one example, the scheduling information is UL scheduling information. In one example, the scheduling information is DL scheduling information and UL scheduling information.

In one example, as illustrated in FIG. 20, dynamic control information is two-stage L1 control, wherein a first stage of the two stage control includes or indicates a number of TCI states or TCI state codepoints indicated. The second stage of the two stage control includes the indicated TCI states or TCI state codepoints, whose number is indicated in the first stage. In one example, the TCI states are activated TCI states. In one example, the TCI states are higher layer configured TCI states (e.g., configured by RRC or SIB signaling).

In one example, as illustrated in FIG. 21, dynamic control information is two-stage L1 control, wherein a first stage of the two stage control includes or indicates a number of TCI states or TCI state codepoints indicated and a first indicated TCI state or a first codepoint (or N first indicated TCI statest or N first codepoints, N>1). The second stage of the two stage control includes the remaining indicated TCI states or remaining TCI state codepoints whose number is indicated in the first stage. In one example, the TCI states are activated TCI states. In one example, the TCI states are higher layer configured TCI states (e.g., configured by RRC or SIB signaling).

In one example, as illustrated in FIG. 22, dynamic control information is two-stage L1 control, wherein a first stage of the two stage control includes a bitmap. The second stage of the two stage control includes a list of indicated TCI states or TCI state codepoints, with a TCI state or TCI state codepoint corresponding to a bit in the bitmap of the first stage. In one example, if a bit in the bitmap corresponding to a TCI state is “1”, the TCI state is indicated to the UE, otherwise if a bit in the bitmap corresponding to a TCI state is “0”, the TCI state is not indicated to the UE. In one example, the TCI states are activated TCI states. In one example, the TCI states are higher layer configured TCI states (e.g., configured by RRC or SIB signaling). In one example, the bitmap has N bits for N TRPs, wherein the first bit corresponds a first TRP, the second bit corresponds to a second TRP, . . . , the Nth bit corresponds to an Nth TRP, wherein N>1. In one example, the bitmap has 2N bits for N TRPs, wherein the first bit corresponds to DL TCI of a first TRP, the second bit corresponds to UL TCI of the first TRP, the third bit corresponds to DL TCI of a second TRP, the fourth bit corresponds to UL TCI of the second TRP, . . . , wherein N≥1. In one example, the bitmap has K bits, wherein K is between N and 2N for N TRPs, some TRPs have one bit for a joint (UL/DL) TCI state, and some TRPs have 2 bits for a separate (DL/UL) TCI state. In the previous examples, a TRP can be replaced by a panel or a beam. In one example, if a TCI state is not indicated (e.g., corresponding bit is zero), the previous value for that TCI state is retained.

A time unit for DL signaling, for UL signaling, or for sidelink (SL) signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB (e.g., the BS 102) transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI)/configured scheduling RNTI (CS-RNTI)/modulation and coding scheme (MCS)-C-RNTI as described in 38.212, are referred for brevity as a unicast DCI format. A DCI format scheduling PDSCH reception for multicast communication, such as a DCI format with CRC scrambled by group RNTI (G-RNTI)/group configured scheduling RNTI (G-CS-RNTI) as described in 38.212, are referred to as multicast DCI format. DCI formats providing various control information to at least a subset of UEs in a serving cell, such as DCI format 2_0 in 38.212, are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As mentioned herein, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the PRB(s) and OFDM symbol(s) where the UE may expect no transmission is intended for the UE; (5) Transmission of transmit power control (TPC) commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the discontinuous reception (DRX) on-duration; (10) In IAB context, indicating the availability for soft symbols of an integrated access and backhaul data unit (IAB-DU); (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, a signal for triggering a measurement report from UE to network, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/physical broadcast channel (PBCH) block (also denoted as SSBs) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal synchronization signal/physical broadcast channel (SS/PBCH) block transmissions.

In absence of CSI-RS configuration, and unless otherwise configured, the UE may expect PDSCH demodulation reference signal (DM-RS) and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

In this disclosure, [DEF1] a beam can be determined by any of:
A TCI state, that establishes a quasi-colocation (QCL) relationship or spatial relation between a source reference signal (e.g. SSB and/or CSI-RS and/or SRS) and a target reference signal
A spatial relation information that establishes an association to a source reference signal, such as SSB or CSI-RS or SRS.

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or TCI state or spatial relation or the one (or two) port(s) identifies the beam.

Alternatively, [DEF3] a beam can be determined by a pair [A, B], which is any of:
[A, B]=[TCI state, port]
[A, B]=[TCI state, PG]
[A, B]=[Spatial relation information, port]
[A, B]=[Spatial relation information, PG]

Where TCI state, Spatial relation information, port and PG are as described herein. In this case, a pair of IDs for [A, B] identifies the beam.

According to [DEF1], the TCI state and/or the spatial relation reference RS can determine a spatial Rx filter or quasi-co-location information for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Likewise, for [DEF2], the port with dynamic virtualization and/or the PG with dynamic indication of one (or two) ports can determine a spatial Rx filter or quasi-co-location information or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB. In one example, a port can be associated with or indicated by a TCI state.

Likewise, for [DEF3], A and B together can determine a spatial Rx filter or quasi-co-location information for reception of downlink channels at the UE, or a spatial Tx filter for transmission of uplink channels from the UE. They can also determine a spatial Tx filter for transmission of downlink channels from the gNB, or a spatial Rx filter for reception of uplink channels at the gNB.

Rel-17 introduced the unified TCI framework, where a unified or main or indicated TCI state is signaled to the UE. The unified o or main or indicated TCI state can be one of:
1. In case of joint TCI state indication, wherein a same beam or port/PG is used for DL and UL channels, a joint TCI state that can be used at least for UE-dedicated DL channels and UE-dedicated UL channels.
2. In case of separate TCI state indication, wherein different beams or ports/PGs are used for DL and UL channels, a DL TCI state that can be used at least for UE-dedicated DL channels.
3. In case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and dedicated PUCCH resources.

The unified TCI framework also applies to intra-cell beam management, wherein, the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that can be directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter} or port/PG

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g. non-UE dedicated channel and sounding reference signal (SRS).

A UE is indicated a TCI state by MAC CE when the CE MAC activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g. format 0_1 or 0_2), wherein the DCI format includes a “transmission configuration indication” field that includes/indicates a TCI state code point out of the TCI state code points activated by a MAC CE. A DL related DCI format (or an UL related DCI format) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state can also be indicated in a purpose designed channel or DCI Format for TCI state indication. A TCI state (TCI state code point) indicated/included in a DL related DCI format or UL related DCI format or purpose design channel or DCI Format for TCI state indication is applied after a beam application time from the corresponding HARQ-ACK feedback.

In this disclosure, aspects related to antenna port activation and indication and beam activation and indication are provided. An antenna port or a beam can be indicated by a TCI state ID or reference signal ID, a TCI state ID or reference signal ID can be for example, an antenna port ID. In one example, an antenna port or TCI state or reference signal represents indication for a channel with one-input and one-output. A unit for spatial relation indication or beam indication can be referred to a spatial relation unit.

In NR, there are different levels of abstraction for beam indication and antenna port indication, which adds unnecessary complexity to MIMO and beam indication. To simplify beam and/or antenna port indication, a spatial resource unit is regarded as the basic unit, wherein the spatial resource unit, is a one-port channel, with one-input and one-output. “An antenna port is defined such that the channel over which a symbol on the antenna port is conveyed can be inferred from the channel over which another symbol on the same antenna port is conveyed” [TS 38.211]. A UE can be indicated with one or more spatial resource unit.

For application of a spatial resource unit, the spatial resource unit is first activated, and then indicated. The activation of a spatial resource unit allows the UE time to measure the spatial resource unit and be ready to use it when it is indicated. The indication of the spatial resource unit is when the UE is signaled to use the spatial resource unit. A UE can be configured multiple spatial resource units. The multiple spatial resource units can be in a same set, or in different sets, for example one set for DL or joint spatial resource units and one set for UL spatial resource units. The UE can then be activated one or more of the spatial resource units. The spatial resource units can be activated in a single set or in multiple sets. The UE can then be indicated one or more spatial resource units from the activated spatial resource units.

In this disclosure a spatial resource unit is defined as a reference signal (e.g., a reference signal with one antenna port) or an antenna port of a reference signal. A spatial resource unit is identified by an ID (e.g., spatial resource unit ID). A spatial resource unit can be referred to as a TCI state, hence, a spatial resource unit ID can be referred to as a TCI state ID. A spatial resource unit can be referred to as an antenna port (or a port), hence, a spatial resource unit ID can be referred to as an antenna port ID or port ID. A spatial resource unit can be referred to as a reference signal, hence, a spatial resource unit ID can be referred to as a reference signal ID.

In this disclosure signaling methods for activation and indication of spatial resource units the signaling overhead of these methods are provided.

The present disclosure relates to a NR/5G and/or 6G communication system.

This disclosure provides aspects related to spatial resource unit configuration activation and indication:
Joint and separate activation and indication of spatial resource unit.
Using combinatorial index or field-map for activation and indication of spatial resource units.
Configuration, activation and indication of spatial resource units using a single set or multiple sets.
Timing aspects of joint activation and indication of spatial resource units.

In the following, both FDD and TDD are evaluated as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE (e.g., the UE 116) wherein the information can be common/cell-specific information or dedicated/UE-specific information or (3) UE-group-common RRC signaling.

In this disclosure MAC CE signaling can be UE-specific e.g., to one UE or can be UE common (e.g., to a group of UEs or to each UE in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or each UE in cell).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CSI-RS resource indicator (CRI) or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In one example of this disclosure, a reference signal can be configured with one antenna port.

In one example of this disclosure, a reference signal can be configured with N antenna ports.

In one example, an entity for spatial domain (or spatial relation) indication (e.g., a spatial domain resource unit) is a TCI state. Wherein, a TCI state can include:
A TCI state ID
One or more QCL information elements. Wherein, a QCL information element can include
   Reference signal ID (e.g., reference signal configured with one antenna port)
   (Optionally) antenna port ID, if reference is configured with more than one antenna port
   One or more QCL Types. (e.g., QCL Type-A or Type-B or Type-C, and/or QCL Type-D)

FIG. 23 illustrates a diagram of example higher layer signaling and dynamic signaling 2300 according to embodiments of the present disclosure. For example, higher layer signaling and dynamic signal 2300 can be received by any of the UEs 111-116 of FIG. 1. This example is for illustration only and other embodiments can be used without departing from the scope of the present disclosure.

In the following examples, as illustrated in FIG. 23, a UE is configured/updated through higher layer RRC signaling a set S1 of spatial resource units or a set S1 of TCI States with L elements or a set S1 of reference signals, e.g., for beam indication with L elements. A subset S2 of K elements (K≤L) is activated from set S1. Where, elements of subset S2 can be activated spatial resource units or spatial resource unit code points or activated TCI states or TCI state code points or reference signals or reference signal code points from the set of L spatial resource units or the set of L TCI states or the set of L reference signal. In one example, subset S2 is referred to as a multi-variate TCI state (e.g., activated multi-variate TCI state (mv-TCI state)). A UE is indicated M elements (denoted as S3) from subset S2. In one example, S3 is referred to as a multi-variate TCI state (e.g., indicated multi-variate TCI state (mv-TCI state)).

In one example, the activation of subset S2 is by higher layer signaling, e.g., MAC CE signaling or RRC signaling. In one example, the activation of subset S2 is by L1 control (e.g., DCI) signaling. In one example, the indication of S3 is by higher layer signaling, e.g., MAC CE signaling or RRC signaling. In one example, the indication of S3 is by L1 control (e.g., DCI) signaling. In one example, the activation of subset of subset S2 and the indication of S3 are in a same signal. In one example, the activation of subset S2 and the indication of S3 is by higher layer signaling, e.g., MAC CE signaling or RRC signaling. In one example, the activation of subset S2 and the indication of S3 is by L1 control (e.g., DCI) signaling.

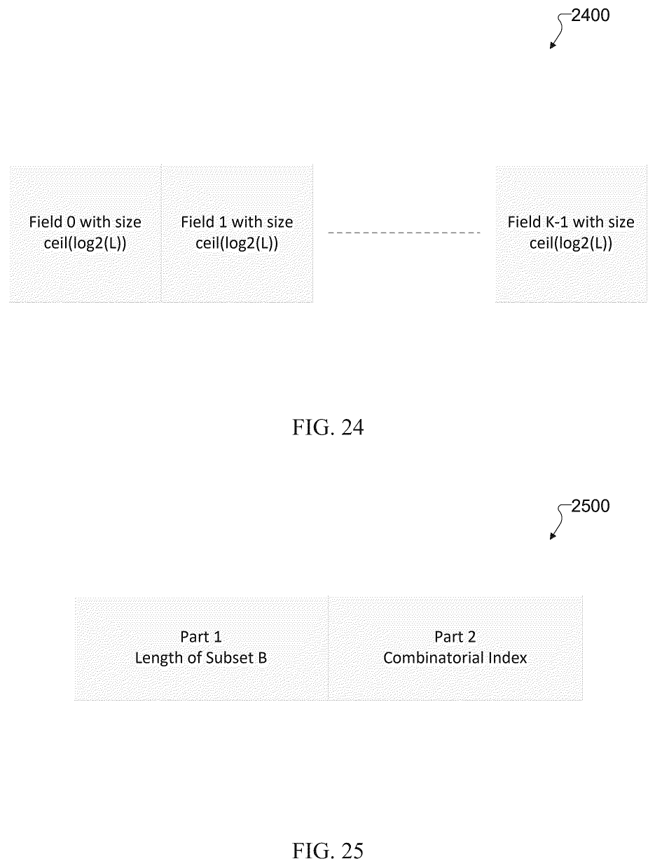

FIG. 24 illustrates a diagram of an example indicator 2400 according to embodiments of the present disclosure. For example, indicator 2400 can be utilized by any of the UEs 111-116 of FIG. 1, such as the UE 111. This example is for illustration only and other embodiments can be used without departing from the scope of the present disclosure.

In one example, to activate K elements from set S1 with L elements, a message, as illustrated in FIG. 24, with K fields is used such that the size of each is ┌log₂ L┐ bits, and indicates one of the L elements of set S1. The size of the message is K┌log₂ L┐. In one example, if K=8 and L=256, the size of the message activating subset S2 is 64 bits.

In one example, the message activating subset S2 is included in a single part message. In one sub-example, the size of the message is independent of the number of elements being activated, for the example, a message can include a maximum number of elements being activated in subset S2, with a special value used for an element not activated, in one example, the size of each field is ┌log₂(L+1)┐, wherein the extra value corresponds to special value used for an element not activated. In a variant example, a field for the number of elements being activated is included in the message activating subset S2 in addition to fields for the maximum number of elements that can be activated in subset S2, if the number of element being activated is K and the maximum number of elements in subset S2 is Kₘₐₓ, then only the first K fields of the Kₘₐₓ fields, convey indices for the activated elements. The remaining Kₘₐₓ−K are reserved or unused. In one sub-example, the size of the message depends on the number of elements being activated, for example, only fields for activated elements are included in the message activating subset S2. In one example, a field for the number of elements being activated is included in the message activating subset S2 in addition to fields for the actual number of elements being activated in subset S2, carrying an index from set S1 for the corresponding activated element.

In one example, the message activating subset S2 is included in two parts. In one example, the first part includes or indicates the number of elements being activated in subset S2. In one example, the second part includes a list of fields to indicate the indices of the elements of subset S2. In one sub-example, the number of fields in the second part is fixed, e.g., equal to the maximum size of subset S2 (e.g., Kₘₐₓ), independent of the number of elements being activated in subset S2. If the first part indicates K elements in subset S2, then only the first K fields of the Kₘₐₓ fields in the second part, convey indices for the activated elements. The remaining Kₘₐₓ−K are reserved or unused. In one sub-example, the number of fields in the second part (and size of second part) depends on the number of elements being activated in subset S2. In one example, a field for the number of elements being activated is included in the first part, e.g., K, and K fields for the actual number of elements being activated in subset S2, are included in the second part carrying an index from set S1 for the corresponding activated element. In one example, N (N≥1) of the K fields are included in the first part. In one example, part 1 is included in a first channel, and part 2 is included in a second channel.

When selecting K elements from set S1 with L elements, there are

$$( \begin{matrix}L \\ K\end{matrix} )$$

choices. A unique combinatorial index can be found for subset S2 {a₀, a₁, . . . , a_{K-1}}, where aₖ for k=0, 1, . . . , K−1, corresponds to an element of set S1 (e.g., an index of an element in set S1 in the range 0, 1, . . . , L−1). If a₀, a₁, . . . , a_{K-1} are arranged in subset S2 such that a₀>a₁> . . . >a_{K-1}, the index of subset S2 is given by:

$${\sum }_{k = 0}^{K - 1} 〈 \begin{matrix}{a}_{k} \\ K - k\end{matrix} 〉 ,$$

where

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the size of the message activating subset B1 is

$$⌈ {log}_{2} ( \begin{matrix}L \\ K\end{matrix} ) ⌉$$

bits. In one example, if K=8 and L=256, the size of the message activating subset S2 is 49 bits.

When selecting up to K elements from set S1 with L elements, there are

$${\sum }_{i = 1}^{K} ( \begin{matrix}L \\ i\end{matrix} )$$

choices. A unique combinatorial index can be found for subset S2 {a₀, a₁, . . . , aᵢ₋₁}, where aₖ for k=0, 1, . . . , i−1, corresponds to an element of set S1 (e.g., an index of an element in set S1 in the range 0, 1, . . . , L−1) with i elements, and where i=1, 2, . . . , K.

FIG. 25 illustrates a diagram of an example indicator 2500 according to embodiments of the present disclosure. For example, indicator 2500 can be utilized by any of the UEs 111-116 of FIG. 1, such as the UE 112. This example is for illustration only and other embodiments can be used without departing from the scope of the present disclosure.

In one example, the message activating subset S2 can include an indicator (e.g., in part 1) of i (e.g., number of spatial resource units being activated), with a size ┌log₂ K┐ bits, and a combinatorial index (e.g., in part 2) corresponding to the i selected elements of subset S2 from set S1, this can be a value in the range

$$0 , 1 , … , ( \begin{matrix}L \\ i\end{matrix} ) - 1.$$

This is illustrated in FIG. 25. In one example, the size of part 2 is variable and depends on the value i indicated in part 1. In one example, the size of part 2 is the maximum value across values of i, the size of this field is maximum when i=K, in which case is corresponds to

$$⌈ {log}_{2} ( \begin{matrix}L \\ K\end{matrix} ) ⌉$$

bits. Hence, the size of the message activating subset B1 is

$$⌈ {log}_{2} K ⌉ + ⌈ {log}_{2} ( \begin{matrix}L \\ K\end{matrix} ) ⌉$$

bit. In one example, if K=8 and L=256, the size of the message activating subset S2 is 52 bits.

In one example, part 1 and part 2 are included in a single part message. In one sub-example, the size of part 1+part 2 is fixed independent of i as mentioned herein. In one sub-example, the size of part 1+part 2 depends on i as mentioned herein. In one example, part 1 and part 2 are included in a same channel.

In one example, part 1 is included in a first part of a message, and part 2 is included in a second part of a message. In one sub-example, the size of part 1 and the size of part 2 are fixed independent of i as mentioned herein. In one sub-example, the size of part 2 depends on i as mentioned herein, the value i is indicated in the first part of the message to assist in determining the size of the second part of the message. In one example, part 1 is included in a first channel, and part 2 is included in a second channel.

In one example, the indices for each length i are arranged in ascending order of i. First the indices for i=1, then the indices for i=2, and so on until the indices for i=K. For example, a combinatorial index for subset S2 {a₀, a₁, . . . , aᵢ₋₁}, can be given by

$${\sum }_{k = 1}^{i - 1} ( \begin{matrix}L \\ k\end{matrix} ) + {\sum }_{k = 0}^{i - 1} 〈 \begin{matrix}{a}_{k} \\ K - k\end{matrix} 〉$$

Where, the first term,

$${\sum }_{k = 1}^{i - 1} ( \begin{matrix}L \\ k\end{matrix} ) ,$$

the sum of indices for a subset S2 of length less than i, and the second term,

$${\sum }_{k = 0}^{i - 1} 〈 \begin{matrix}{a}_{k} \\ K - k\end{matrix} 〉 ,$$

is the combinatorial index for the selected elements of subset S2 of length i. Hence, the size of the message activating subset S2 of length up to K elements is

$$⌈ {log}_{2} {\sum }_{i = 1}^{K} ( \begin{matrix}L \\ i\end{matrix} ) ⌉ .$$

In one example, if K=8 and L=256, the size of the message activating subset S2 is 49 bits.

In one example, the indices for each length i are arranged in descending order of i. First the indices for i=K, then the indices for i=K−1, and so on until the indices for i=1. For example, a combinatorial index for subset S2 {a₀, a₁, . . . , aᵢ₋₁}, can be given by

$${\sum }_{k = i + 1}^{K} ( \begin{matrix}L \\ k\end{matrix} ) + {\sum }_{k = 0}^{i - 1} 〈 \begin{matrix}{a}_{k} \\ K - k\end{matrix} 〉$$

Where, the first term,

$${\sum }_{k = i + 1}^{K} ( \begin{matrix}L \\ k\end{matrix} ) ,$$

the sum of indices for a subset S2 of length greater than i, and the second term,

$${\sum }_{k = 0}^{i - 1} 〈 \begin{matrix}{a}_{k} \\ K - k\end{matrix} 〉 ,$$

is the combinatorial index for the selected elements of subset S2 of length i. Hence, the size of the message activating subset S2 of length up to K elements is

$$⌈ {log}_{2} {\sum }_{i = 1}^{K} ( \begin{matrix}L \\ i\end{matrix} ) ⌉ .$$

In one example, if K=8 and L=256, the size of the message activating subset S2 is 49 bits.

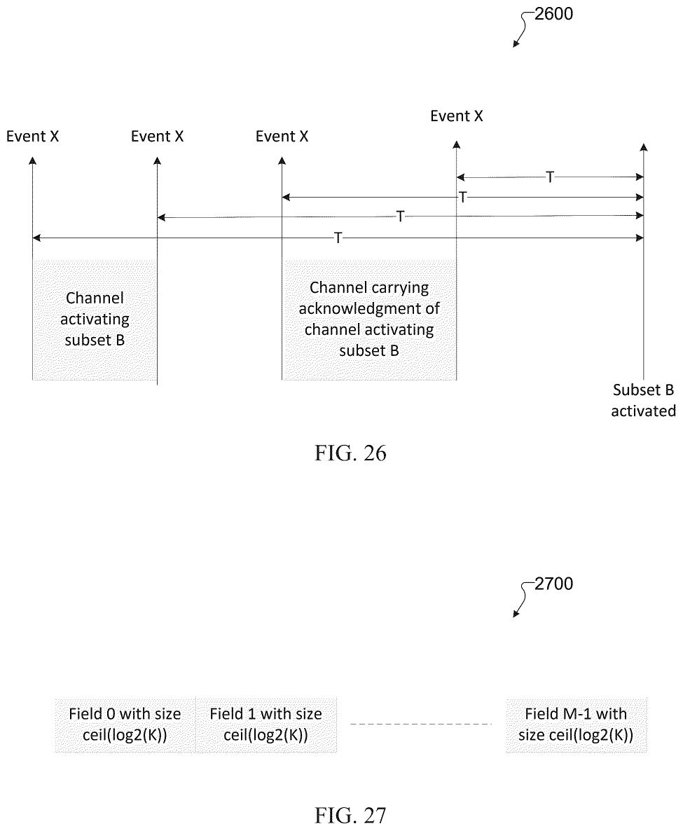

FIG. 26 illustrates a diagram of example events 2600 for activating subset B according to embodiments of the present disclosure. For example, events 2600 can indicate to any of the UEs 111-116 of FIG. 1, such as the UE 111. This example is for illustration only and other embodiments can be used without departing from the scope of the present disclosure.

In one example, a network (e.g., the network 130) transmits a message to a UE to activate subset B as illustrated in FIG. 26. The UE transmits an acknowledgement to the message activating subset B as illustrated in FIG. 26. In one example, subset B is activated after event X by a time T. In one example, subset B is activated at the first time-unit boundary at or after event X by T. In one example, a time-unit is as mentioned herein. For example, a time-unit can be a slot or a sub-frame. In one example, event X is the start of the channel activating subset B. In one example, event X is the end of the channel activating subset B. In one example, event X is the start of the channel activating subset B, and the channel is positively acknowledged. In one example, event X is the end of the channel activating subset B, and the channel is positively acknowledged. In one example, event X is the start of the channel carrying the acknowledgment (e.g., positive acknowledgement) of the channel activating subset B. In one example, event X is the end of the channel carrying the acknowledgment (e.g., positive acknowledgement) of the channel activating subset B. In one example, T can be configured and/or updated by SIB signaling and/or RRC signaling and/or MAC CE signaling and/or L1 control (e.g., DCI) signaling.

In one example, after event Y and until subset B has been activated, the UE doesn't apply new spatial resource units, or new TCI states, or new reference signals, e.g., no indication of S3. In one example, event Y is the same as event X. In one example, event Y can be different from event X. In one example, event Y is a time T2 after event X. In one example, event Y is at a time-unit starting at or after a time T2 from event X. In one example, a time-unit is as mentioned herein. For example, a time-unit can be a slot or a sub-frame. In one example, event Y is the start of the channel activating subset B. In one example, event Y is the end of the channel activating subset B. In one example, event Y is the start of the channel activating subset B, and the channel is positively acknowledged. In one example, event Y is the end of the channel activating subset B, and the channel is positively acknowledged. In one example, event Y is the start of the channel carrying the acknowledgment (e.g., positive acknowledgement) of the channel activating subset B. In one example, event Y is the end of the channel carrying the acknowledgment (e.g., positive acknowledgement) of the channel activating subset B. In one example, T2 can be configured and/or updated by SIB signaling and/or RRC signaling and/or MAC CE signaling and/or L1 control (e.g., DCI) signaling.

In one example, at or after subset B has been activated, as illustrated in FIG. 26, S3 can be indicated from the most recently activated subset B. In one example, event Z occurs at or after subset B is activated. In one example, event Z occurs at or after a time T3 from the time subset B is activated. In one example, event Z occurs at a time-unit boundary. In one example, a time-unit is as mentioned herein. For example, a time-unit can be a slot or a sub-frame. In one example, event Z is the start of the channel indicating S3. In one example, event Z is the end of the channel indicating S3. In one example, event Z is the start of the channel carrying the acknowledgment (e.g., positive acknowledgement) of the channel indicating S3. In one example, event Z is the end of the channel carrying the acknowledgment (e.g., positive acknowledgement) of the channel indicating S3. In one example, T3 can be configured and/or updated by SIB signaling and/or RRC signaling and/or MAC CE signaling and/or L1 control (e.g., DCI) signaling.

In one example, when subset B is activated, the currently applied spatial resource units or TCI states or reference signals, (S3) are included in subset B.

In one example, when subset B is activated, at least one of the currently applied spatial resource units or TCI states or reference signals, (e.g., at least one of S3) included in subset B.

In one example, when subset B is activated, there is no restriction on subset B with regards to the currently applied S3.

FIG. 27 illustrates a diagram of an example indicator 2700 according to embodiments of the present disclosure. For example, indicator 2700 can be utilized by any of the UEs 111-116 of FIG. 1, such as the UE 113. This example is for illustration only and other embodiments can be used without departing from the scope of the present disclosure.

In one example, to indicate M elements from set S2 with K elements, a message, as illustrate in FIG. 27, with M fields is used such that the size of each is ┌log₂ K┐ bits, and indicates one of the K elements of subset S2. The size of the message is M┌log₂ K┐. In one example, if M=4 and K=8, the size of the message activating subset S2 is 12 bits.

In one example, the message indicating S3 is included in a single part message. In one sub-example, the size of the message is independent of the number of elements being indicated, for the example, a message can include a maximum number of elements being indicated in S3, with a special value can be used for an element not indicated, in one example, the size of each field is ┌log₂(K+1)┐, wherein the extra value corresponds to special value used for an element not indicated. In a variant example, a field for the number of elements being indicated is included in the message indicating S3 in addition to fields for the maximum number of elements that can be indicated in S3, if the number of element being indicated is M and the maximum number of elements in S3 is Mₘₐₓ, then only the first M fields of the Mₘₐₓ fields, convey indices for the indicated elements. The remaining Mₘₐₓ−M are reserved or unused. In one sub-example, the size of the message depends on the number of elements being indicated, for example, only fields for indicated elements are included in the message indicating S3. In one example, a field for the number of elements being indicated is included in the message indicating S3 in addition to fields for the actual number of elements being indicated in S3, carrying an index from subset S2 for the corresponding indicated element.

In one example, the message indicating S3 is included in two parts. In one example, the first part includes or indicates the number of elements being indicated in S3. In one example, the second part includes a list of fields to indicate the indices of the elements of S3. In one sub-example, the number of fields in the second part is fixed, e.g., equal to the maximum size of S3 (e.g., Mₘₐₓ), independent of the number of elements being indicated in S3. If the first part indicates M elements in S3, then only the first M fields of the Mₘₐₓ fields in the second part, convey indices for the indicated elements. The remaining Mₘₐₓ−M are reserved or unused. In one sub-example, the number of fields in the second part (and size of second part) depends on the number of elements being indicated in S3. In one example, a field for the number of elements being indicated is included in the first part, e.g., M, and M fields for the actual number of elements being indicated in S3, are included in the second part carrying an index from subset S2 for the corresponding indicated element. In one example, N (N≥1) of the M fields are included in the first part. In one example, part 1 is included in a first channel, and part 2 is included in a second channel.

When selecting M elements from subset S2 with K elements, there are

$$( \begin{matrix}K \\ M\end{matrix} )$$

choices. A unique combinatorial index can be found for S3 {b₀, b₁, . . . , b_{M-1}}, where aₘ for m=0, 1, . . . , K−1, corresponds to an element of subset S2 (e.g., an index of an element in subset S2 in the range 0, 1, . . . , K−1). If b₀, b₁, . . . , b_{K-1} are arranged in S3 such that b₀>b₁> . . . >b_{M-1}, the index of S3 is given by:

$${\sum }_{m = 0}^{M - 1} 〈 \begin{matrix}{a}_{m} \\ M - m\end{matrix} 〉 ,$$

where

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the size of the message indicting subset S3 is

$$⌈ {log}_{2} ( \begin{matrix}K \\ M\end{matrix} ) ⌉$$

bits. In one example, if M=4 and K=8, the size of the message indicating S3 is 7 bits.

When selecting up to M elements from subset S2 with K elements, there are

$${\sum }_{i = 1}^{M} ( \begin{matrix}K \\ i\end{matrix} )$$

choices. A unique combinatorial index can be found for S3 {b₀, b₁, . . . , bᵢ₋₁}, where bₘ for m=0, 1, . . . , i−1, corresponds to an element of subset S2 (e.g., an index of an element in subset S2 in the range 0, 1, . . . , K−1) with i elements, and where i=1, 2, . . . , M.

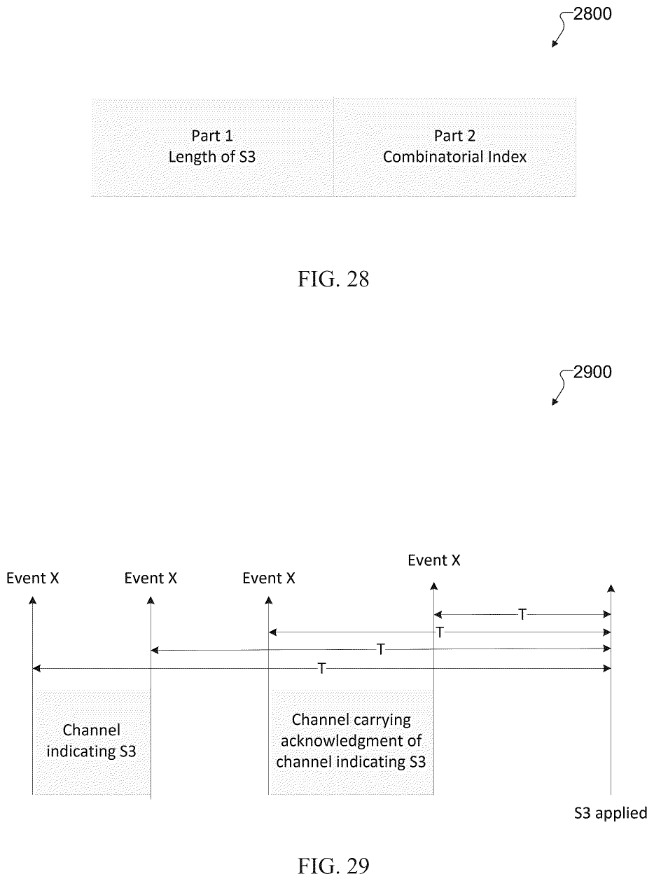

FIG. 28 illustrates a diagram of an example indicator 2800 according to embodiments of the present disclosure. For example, indicator 2800 can be utilized by any of the UEs 111-116 of FIG. 1, such as the UE 114. This example is for illustration only and other embodiments can be used without departing from the scope of the present disclosure.

In one example, the message indicating S3 can include an indicator (e.g., in part 1) of i (e.g., number of spatial resource units being indicated), with a size ┌log₂ M┐ bits, and a combinatorial index (e.g., in part 2) corresponding to the i selected elements of S3 from subset S2, this can be a value in the range

$$0 , 1 , … , ( \begin{matrix}M \\ i\end{matrix} ) - 1 .$$

This is illustrated in FIG. 28. In one example, the size of part 2 is variable and depends on the value i indicated in part 1. In one example, the size of part 2 is the maximum value across values of i, the size of this field is maximum when i=M, in which case is corresponds to

$$⌈ {log}_{2} ( \begin{matrix}K \\ M\end{matrix} ) ⌉$$

bits. Hence, the size of the message indicating S3 is

$$⌈ {log}_{2} M ⌉ + ⌈ {log}_{2} ( \begin{matrix}K \\ M\end{matrix} ) ⌉$$

bit. In one example, if M=4 and K=8, the size of the message activating subset S2 is 9 bits.

In one example, part 1 and part 2 are included in a single part message. In one sub-example, the size of part 1+part 2 is fixed independent of i as mentioned herein. In one sub-example, the size of part 1+part 2 depends on i as mentioned herein. In one example, part 1 and part 2 are included in a same channel.

In one example, part 1 is included in a first part of a message, and part 2 is included in a second part of a message. In one sub-example, the size of part 1 and the size of part 2 are fixed independent of i as mentioned herein. In one sub-example, the size of part 2 depends on i as mentioned herein, the value i is indicated in the first part of the message to assist in determining the size of the second part of the message. In one example, part 1 is included in a first channel, and part 2 is included in a second channel.

In one example, the indices for each length i are arranged in ascending order of i. First the indices for i=1, then the indices for i=2, and so on until the indices for i=M. For example, a combinatorial index for S3 {b₀, b₁, . . . , bᵢ₋₁}, can be given by

$${\sum }_{m = 1}^{i - 1} ( \begin{matrix}K \\ m\end{matrix} ) + {\sum }_{m = 0}^{i - 1} 〈 \begin{matrix}{b}_{m} \\ M - m\end{matrix} 〉$$

Where, the first term,

$${\sum }_{m = 1}^{i - 1} ( \begin{matrix}M \\ m\end{matrix} ) ,$$

the sum of indices for S3 of length less than i, and the second term,

$${\sum }_{m = 0}^{i - 1} 〈 \begin{matrix}{b}_{m} \\ M - m\end{matrix} 〉 ,$$

is the combinatorial index for the selected elements of S3 of length i. Hence, the size of the message indicating S3 of length up to M elements is

$$⌈ {log}_{2} {\sum }_{i = 1}^{M} ( \begin{matrix}M \\ i\end{matrix} ) ⌉ .$$

In one example, if M=4 and K=8, the size of the message indicating S3 is 8 bits.

In one example, the indices for each length i are arranged in descending order of i. First the indices for i=M, then the indices for i=M−1, and so on until the indices for i=1. For example, a combinatorial index for S3 {b₀, b₁, . . . , bᵢ₋₁}, can be given by

$${\sum }_{m = i + 1}^{M} ( \begin{matrix}K \\ m\end{matrix} ) + {\sum }_{m = 0}^{i - 1} 〈 \begin{matrix}{b}_{m} \\ M - m\end{matrix} 〉$$

Where, the first term,

$${\sum }_{m = i + 1}^{M} ( \begin{matrix}L \\ m\end{matrix} ) ,$$

the sum of indices for S3 of length greater than i, and the second term,

$${\sum }_{m = 0}^{i - 1} 〈 \begin{matrix}{b}_{m} \\ M - m\end{matrix} 〉 ,$$

is the combinatorial index for the selected elements of S3 of length i. Hence, the size of the message activating subset S2 of length up to M elements is

$$⌈ {log}_{2} {\sum }_{i = 1}^{M} ( \begin{matrix}K \\ i\end{matrix} ) ⌉ .$$

In one example, if M=4 and K=8, the size of the message indicating S3 is 8 bits.

FIG. 29 illustrates a diagram of example events 2900 for applying S3 according to embodiments of the present disclosure. For example, events 2900 can indicate to any of the UEs 111-116 of FIG. 1, such as the UE 111. This example is for illustration only and other embodiments can be used without departing from the scope of the present disclosure.

In one example, a network transmits a message to a UE (e.g., the UE 116) indicating S3 as illustrated in FIG. 29. The UE transmits an acknowledgement to the message indicating S3 as illustrated in FIG. 29. In one example, S3 is applied after event X by a time T. In one example, S3 is applied at the first time-unit boundary at or after event X by T. In one example, a time-unit is as mentioned herein. For example, a time-unit can be a slot or a sub-frame. In one example, event X is the start of the channel indicating S3. In one example, event X is the end of the channel indicating S3. In one example, event X is the start of the channel indicating S3, and the channel is positively acknowledged. In one example, event X is the end of the channel indicating S3, and the channel is positively acknowledged. In one example, event X is the start of the channel carrying the acknowledgment (e.g., positive acknowledgement) of the channel indicating S3. In one example, event X is the end of the channel carrying the acknowledgment (e.g., positive acknowledgement) of the channel indicating S3. In one example, T can be configured and/or updated by SIB signaling and/or RRC signaling and/or MAC CE signaling and/or L1 control (e.g., DCI) signaling.

In one example, after event Y and until S3 has been applied, the UE doesn't activate new spatial resource units, or new TCI states, or new reference signals, e.g., no activation of subset B. In one example, if a new activation of subset S2 is received it is dropped or ignored. In one example, event Y is the same as event X. In one example, event Y can be different from event X. In one example, event Y is a time T2 after event X. In one example, event Y is at a time-unit starting at or after a time T2 from event X. In one example, a time-unit is as mentioned herein. For example, a time-unit can be a slot or a sub-frame. In one example, event Y is the start of the channel indicating S3. In one example, event Y is the end of the channel indicating S3. In one example, event Y is the start of the channel indicating S3, and the channel is positively acknowledged. In one example, event Y is the end of the channel indicating S3, and the channel is positively acknowledged. In one example, event Y is the start of the channel carrying the acknowledgment (e.g., positive acknowledgement) of the channel indicating S3. In one example, event Y is the end of the channel carrying the acknowledgment (e.g., positive acknowledgement) of the channel indicating S3. In one example, T2 can be configured and/or updated by SIB signaling and/or RRC signaling and/or MAC CE signaling and/or L1 control (e.g., DCI) signaling.

In one example, S3 is from the most recently activated subset S2.

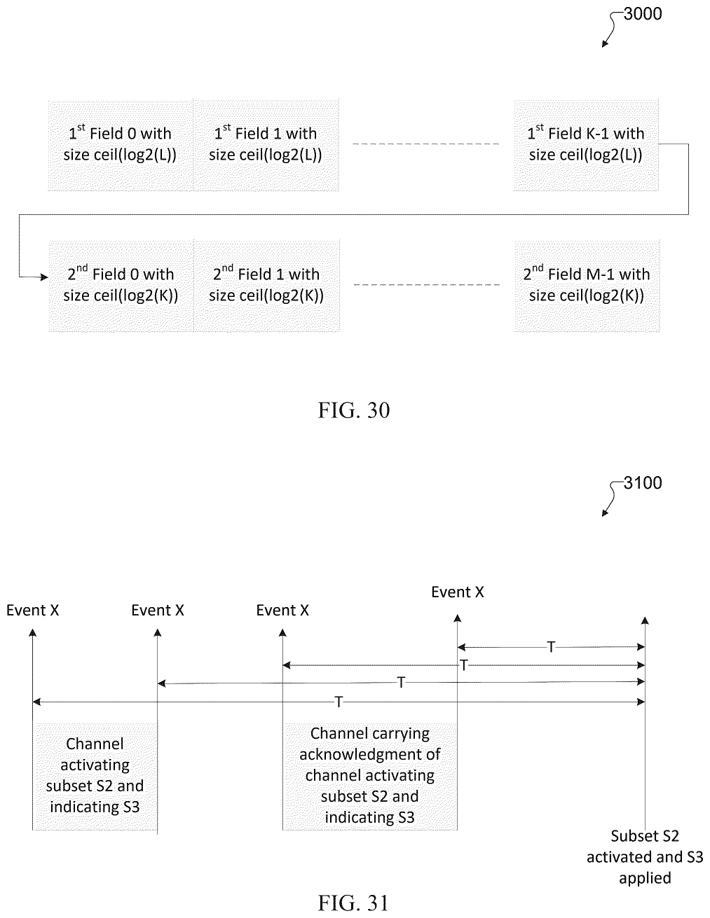

FIG. 30 illustrates a diagram of an example indicator 3000 according to embodiments of the present disclosure. For example, indicator 3000 can be utilized the UE 116 of FIG. 3. This example is for illustration only and other embodiments can be used without departing from the scope of the present disclosure.

In one example, to activate subset S2 with K elements from set S1 with L elements, and to indicate S3 with M elements from the K elements of subset S2 a message, as illustrated in FIG. 30, with K first fields and M second fields is used such that the size of a first field is ┌log₂ L┐ bits and indicates one of the L elements of set S1, and the size of a second field is ┌log₂ K┐ bits and indicates one of the K elements of subset S2. The size of the message is K┌log₂ L┐+M┌log₂ K┐. In one example, if M=8, K=8 and L=256, the size of the message activating subset S2 and indicating S3 is 64+12=76 bits.

In one example, the message activating subset S2 and indicating S3 is included in a single part message. In one sub-example, the size of the message is independent of the number of elements being activated, for the example, a message can include a maximum number of first elements being activated in subset S2, with a special value used for a first element not activated, in one example, the size of each field is ┌log₂(L+1)┐, wherein the extra value corresponds to special value used for an element not activated. In one sub-example, the size of the message is independent of the number of elements being indicated, for the example, a message can include a maximum number of second elements being indicated in S3, with a special value used for a second element not indicated, in one example, the size of each field is ┌log₂(K+1)┐, wherein the extra value corresponds to special value used for an element not indicated. In a variant example, a field for the number of first elements being activated is included in the message activating subset S2 in addition to first fields for the maximum number of elements that can be activated in subset S2, if the number of first element being activated is K and the maximum number of first elements in subset S2 is Kₘₐₓ, then only the first K first fields of the Kₘₐₓ first fields, convey indices for the activated elements. The remaining Kₘₐₓ−K are reserved or unused. In a one example, a field for the number of second elements being indicated is included in the message indication S3 in addition to second fields for the maximum number of elements that can be indicated in S3, if the number of second element being indicated is M and the maximum number of second elements in S3 is Mₘₐₓ, then only the first M second fields of the Mₘₐₓ second fields, convey indices for the indicated elements. The remaining Mₘₐₓ−M are reserved or unused. In one sub-example, the size of the message depends on the number of elements being activated, for example, only fields for activated elements are included in the message activating subset S2. In one example, a field for the number of first elements being activated is included in the message activating subset S2 in addition to first fields for the actual number of elements being activated in subset S2, carrying an index from set S1 for the corresponding activated element. In one example, a field for the number of second elements being indicated is included in the message indicating S3 in addition to second fields for the actual number of elements being indicated in S3, carrying an index from subset S2 for the corresponding indicated element.

In one example, the message activating subset S2 and indicting S3 is included in two parts. In one example, the first part includes or indicates the number of first elements being activated in subset S2 and/or the number of second elements being indicated in S3. In one example, the second part includes a list of first fields to indicate the indices of the elements of subset S2. In one sub-example, the number of first fields in the second part is fixed, e.g., equal to the maximum size of subset S2 (e.g., Kₘₐₓ), independent of the number of first elements being activated in subset S2. If the first part indicates K first elements in subset S2, then only the first K first fields of the Kₘₐₓ first fields in the second part, convey indices for the activated elements. The remaining Kₘₐₓ−K are reserved or unused. In one sub-example, the number of first fields in the second part [and size of second part] depends on the number of first elements being activated in subset S2. In one example, a field for the number of first elements being activated is included or indicated in the first part, e.g., K, and K first fields for the actual number of first elements being activated in subset S2, are included in the second part carrying an index from set S1 for the corresponding activated element. In one example, the second part includes a list of second fields to indicate the indices of the elements of S3. In one sub-example, the number of second fields in the second part is fixed, e.g., equal to the maximum size of S3 (e.g., Mₘₐₓ), independent of the number of second elements being indicated in S3. If the first part indicates M second elements in S3, then only the first M second fields of the Mₘₐₓ second fields in the second part, convey indices for the indicated elements. The remaining Mₘₐₓ−M are reserved or unused. In one sub-example, the number of second fields in the second part (and size of second part) depends on the number of second elements being indicated in S3. In one example, a field for the number of second elements being indicated is included or indicated in the first part, e.g., M, and M second fields for the actual number of second elements being indicated in S3, are included in the second part carrying an index from subset S2 for the corresponding indicated element. In one example, N1 (N1≥1) of the K fields are included in the first part. In one example, N2 (N2≥1) of the M fields are included in the first part. In one example, part 1, of the message activating and indicating TCI states, is included in a first channel, and part 2, of the message activating and indicating TCI states, is included in a second channel.

In one example, a field for the number of first elements is included or indicated in the first part, and a field for the number of second elements is included or indicated in the second part. In one example, a field for the number of first elements is included or indicated in the first part, and a field for the number of second elements is included or indicated in the first part. In one example, a field for the number of first elements is included or indicated in the second part, and a field for the number of second elements is included or indicated in the first part. In one example, a field for the number of first elements is included or indicated in the second part, and a field for the number of second elements is included or indicated in the second part. In one example, a field for the number of first elements is included or indicated in the first part, there is no field for the number of second elements the maximum number of second fields, e.g., Mₘₐₓ, is included in the message (e.g., second part and/or first part). In one example, a field for the number of second elements is included or indicated in the first part, there is no field for the number of first elements the maximum number of first fields, e.g., Kₘₐₓ, is included in the message (e.g., second part and/or first part).

When selecting K elements from set S1 with L elements, there are

$$( \begin{matrix}L \\ K\end{matrix} )$$

choices. A unique combinatorial index can be found for subset S2 {a₀, a₁, . . . , a_{K-1}}, where aₖ for k=0, 1, . . . , K−1, corresponds to an element of set S1 (e.g., an index of an element in set S1 in the range 0, 1, . . . , L−1). If a₀, a₁, . . . , a_{K-1} are arranged in subset S2 such that a₀>a₁> . . . >a_{K-1}, the index of subset S2 is given by:

$${\sum }_{k = 0}^{K - 1} 〈 \begin{matrix}{a}_{k} \\ K - k\end{matrix} 〉 .$$

When selecting M elements from subset S2 with K elements, there are

$$( \begin{matrix}K \\ M\end{matrix} )$$

choices. A unique combinatorial index can be found for S3 {b₀, b₁, . . . , b_{M-1}}, where bₘ for m=0, 1, . . . , M−1, corresponds to an element of subset S2 (e.g., an index of an element in subset S2 in the range 0, 1, . . . , K−1). If b₀, b₁, . . . , b_{M-1} are arranged in S3 such that b₀>b₁> . . . >b_{K-1}, the index of S3 is given by:

$${\sum }_{m = 0}^{M - 1} 〈 \begin{matrix}{b}_{m} \\ M - m\end{matrix} 〉 ,$$

where

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the size of the message activating subset S2 and indicating S3 is

$$⌈ {log}_{2} ( \begin{matrix}L \\ K\end{matrix} ) ⌉ + ⌈ {log}_{2} ( \begin{matrix}K \\ M\end{matrix} ) ⌉$$

bits. In one example, if M=4, K=8 and L=256, the size of the message activating subset S2 is 49+7=56 bits.

When selecting up to K elements from set S1 with L elements, there are

$${\sum }_{i = 1}^{K} ( \begin{matrix}L \\ i\end{matrix} )$$

choices as described herein in this disclosure. In one example, a first part can include the length (e.g., number of elements in) subset S2, and a second part includes a combinatorial index based on the length of S2 as described herein in this disclosure. The combinatorial index can have a fixed bit-width (e.g., corresponding to the maximum across lengths) or a variable bit-width depending on the length of S2 as described herein in this disclosure.

When selecting up to M elements from subset S2 with M elements, there are

$${\sum }_{i = 1}^{M} ( \begin{matrix}M \\ i\end{matrix} )$$

choices as described herein in this disclosure. In one example, a first part can include the length (e.g., number of elements in) S3, and a second part includes a combinatorial index based on the length of S3 as described herein in this disclosure. The combinatorial index can have a fixed bit-width (e.g., corresponding to the maximum across lengths) or a variable bit-width depending on the length of S3 as described herein in this disclosure.

The indication of S2 and S3, in a message, can be according to one of the examples mentioned herein for S2 and according to one of the examples mentioned herein for S3 respectively. The following are examples of such indication:
Example 1: S2 is indicated using a list of first fields for elements of S2, optionally, a field indicating the length (e.g., number of first elements) of S2 can be include in the message. In one example, the information for indicating S2 can have a fixed size (e.g., fixed bit-width) in the message. In one example, the information for indicating S2 can have a variable size (e.g., variable bit-width) in the message, e.g., depending on length (e.g., number of first elements) of S2 included in the message. S3 is indicated using a list of second fields for elements of S3, optionally, a field indicating the length (e.g., number of second elements) of S3 can be include in the message. In one example, the information for indicating S3 can have a fixed size (e.g., fixed bit-width) in the message. In one example, the information for indicating S3 can have a variable size (e.g., variable bit-width) in the message, e.g., depending on length (e.g., number of second elements) of S3 included in the message.
Example 2: S2 is indicated using a list of first fields for elements of S2, optionally, a field indicating the length (e.g., number of first elements) of S2 can be include in the message. In one example, the information for indicating S2 can have a fixed size (e.g., fixed bit-width) in the message. In one example, the information for indicating S2 can have a variable size (e.g., variable bit-width) in the message, e.g., depending on length (e.g., number of first elements) of S2 included in the message. S3 is indicated using combinatorial index. In one example, S3 is indicated using a fixed number of second elements (e.g., M elements). In one example, S3 is indicated using a variable number of second elements (e.g., up to M elements). In one example, the number of second elements in S3 is included in the message. In one example, the information for indicating S3 can have a fixed size (e.g., fixed bit-width) in the message. In one example, the information for indicating S3 can have a variable size (e.g., variable bit-width) in the message, e.g., depending on length (e.g., number of second elements) of S3 included in the message.
Example 3: S2 is indicated using combinatorial index. In one example, S2 is indicated using a fixed number of first elements (e.g., K elements). In one example, S2 is indicated using a variable number of first elements (e.g., up to K elements). In one example, the number of first elements in S2 is included in the message. In one example, the information for indicating S2 can have a fixed size (e.g., fixed bit-width) in the message. In one example, the information for indicating S2 can have a variable size (e.g., variable bit-width) in the message, e.g., depending on length (e.g., number of first elements) of S2 included in the message. S3 is indicated using a list of second fields for elements of S3, optionally, a field indicating the length (e.g., number of second elements) of S3 can be include in the message. In one example, the information for indicating S3 can have a fixed size (e.g., fixed bit-width) in the message. In one example, the information for indicating S3 can have a variable size (e.g., variable bit-width) in the message, e.g., depending on length (e.g., number of second elements) of S3 included in the message.
Example 4: S2 is indicated using combinatorial index. In one example, S2 is indicated using a fixed number of first elements (e.g., K elements). In one example, S2 is indicated using a variable number of first elements (e.g., up to K elements). In one example, the number of first elements in S2 is included in the message. In one example, the information for indicating S2 can have a fixed size (e.g., fixed bit-width) in the message. In one example, the information for indicating S2 can have a variable size (e.g., variable bit-width) in the message, e.g., depending on length (e.g., number of first elements) of S2 included in the message. S3 is indicated using combinatorial index. In one example, S3 is indicated using a fixed number of second elements (e.g., M elements). In one example, S3 is indicated using a variable number of second elements (e.g., up to M elements). In one example, the number of second elements in S3 is included in the message. In one example, the information for indicating S3 can have a fixed size (e.g., fixed bit-width) in the message. In one example, the information for indicating S3 can have a variable size (e.g., variable bit-width) in the message, e.g., depending on length (e.g., number of second elements) of S3 included in the message.

In one example, the message for activating subset S2 and indicating S3 can be signal part message as described herein. In one example, the message for activating subset S2 and indicating S3 can be a two-part message. In one example, the first part includes information to indicate the length/size of the second part (e.g., the length/size) of the second part can be variable. In one example, the first part and the second part are fixed length/size. The following are examples of information included in the first part and the second part:
Example 1: First part includes information for S2. Second part includes information for S3.
Example 2: First part includes information for S3. Second part includes information for S2.
Example 3: First part includes information about length (e.g., number of first elements) of S2, and first part includes information about length (e.g., number of second elements) of S3. Second part includes first elements of S2 (e.g., as a list of fields for first elements of S2 or as a combinatorial index for first elements of S2), second part includes second elements of S3 (e.g., as a list of fields for second elements of S3 or as a combinatorial index for second elements of S3). In one example, the length/size of information of S2 (e.g., in second part) is variable (e.g., depends on information indicated in first part). In one example, the length/size of information of S2 (e.g., in second part) is fixed. In one example, the length/size of information of S3 (e.g., in second part) is variable (e.g., depends on information indicated in first part). In one example, the length/size of information of S3 (e.g., in second part) is fixed. In one example one or more of the first elements of S2 is included in first part. In one example one or more of the second elements of S3 is included in first part.
Example 3: First part includes information about length (e.g., number of first elements) of S2. Second part includes first elements of S2 (e.g., as a list of fields for first elements of S2 or as a combinatorial index for first elements of S2). In one example, the length/size of information of S2 (e.g., in second part) is variable (e.g., depends on information indicated in first part). In one example, the length/size of information of S2 (e.g., in second part) is fixed. In one example one or more of the first elements of S2 is included in first part. In one example, second part includes information for S3. In example, first part includes information for S3. In one example, information for S3 is split between first part and second part, for example first part includes one or more second elements of S3, second part includes remaining second elements of S3.
Example 4: First part includes information about length (e.g., number of second elements) of S3. Second part includes second elements of S3 (e.g., as a list of fields for second elements of S3 or as a combinatorial index for second elements of S3). In one example, the length/size of information of S3 (e.g., in second part) is variable (e.g., depends on information indicated in first part). In one example, the length/size of information of S3 (e.g., in second part) is fixed. In one example one or more of the second elements of S3 is included in first part. In one example, second part includes information for S2. In example, first part includes information for S2. In one example, information for S2 is split between first part and second part, for example first part includes one or more first elements of S2, second part includes remaining first elements of S2.

In a variant of the examples herein, the message (e.g., signal part or two-parts with part 1 and part 2) includes subset S2. There is no S3.

In a variant of the examples herein, the message (e.g., signal part or two-parts with part 1 and part 2) includes subset S3. There is no S2.

FIG. 31 illustrates a diagram of example events 3100 for activating subset S2 and applying S3 according to embodiments of the present disclosure. For example, events 3100 can indicate to any of the UEs 111-116 of FIG. 1, such as the UE 111. This example is for illustration only and other embodiments can be used without departing from the scope of the present disclosure.

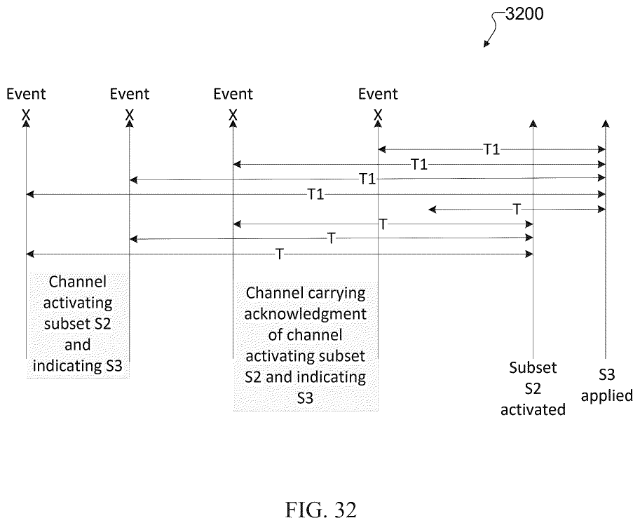

FIG. 32 illustrates a diagram of example events 3200 for activating subset S2 and applying S3 according to embodiments of the present disclosure. For example, events 3200 can indicate to any of the UEs 111-116 of FIG. 1, such as the UE 111. This example is for illustration only and other embodiments can be used without departing from the scope of the present disclosure.

In one example, a network (e.g., the network 130) transmits a message to a UE to activate subset S2 and to indicate S3 as illustrated in FIG. 31 and FIG. 32. The UE transmits an acknowledgement to the message activating subset S2 and indicating S3 as illustrated in FIG. 31 and FIG. 32. In one example, subset S2 is activated and S3 is applied after event X by a time T as illustrated in FIG. 31. In one example, subset S2 is activated and S3 is applied at the first time-unit boundary at or after event X by T. In one example, subset S2 is activated after event X by a time T, and S3 is applied after event X by time T1 as illustrated in FIG. 32. In one example, subset S2 is activated at the first time-unit boundary at or after event X by T, and S3 is applied at the first time-unit boundary at or after event X by T1. In one example, a time-unit is as mentioned herein. For example, a time-unit can be a slot or a sub-frame. In one example, event X is the start of the channel activating subset S2 and indicating S3. In one example, event X is the end of the channel activating subset S2 and indicating S3. In one example, event X is the start of the channel activating subset S1 and indicating S3, and the channel is positively acknowledged. In one example, event X is the end of the channel activating subset S2 and indicating S3, and the channel is positively acknowledged. In one example, event X is the start of the channel carrying the acknowledgment (e.g., positive acknowledgement) of the channel activating subset S2 and indicating S3. In one example, event X is the end of the channel carrying the acknowledgment (e.g., positive acknowledgement) of the channel activating subset S2 and indicating S3. In one example, T and/or T1 can be configured and/or updated by SIB signaling and/or RRC signaling and/or MAC CE signaling and/or L1 control (e.g., DCI) signaling.

In one example, the message to activate subset S2 and to indicate S3 can include:
Activated subset S2 and indicated S3.
   In one example, subset S2 can be activated after time T, and S3 can be applied after time T as mentioned herein.
   In one example, subset S2 can be activated after time T, and S3 can be applied after time T1 as mentioned herein.
Activated subset S2 (e.g., with no indicated S3). In one example, subset S2 can be activated after time Ta. In one example, Ta can be T. In one example, Ta can be a separately configured value.
Indicated S3 (e.g., with no activated subset S2, the indicated S3 can be based on a previously activated subset S2). In one example, S3 can be indicated after time T1. In one example, T1 can be T. In one example, T1 can be T1. In one example, Ta can be a separately configured value.

In one example, after event Y and until subset S2 has been activated or S3 has been applied, the UE doesn't apply new spatial resource units or new TCI states, or new reference signals, e.g., no new indication of S3. In one example, event Y is the same as event X. In one example, event Y can be different from event X. In one example, event Y is a time T2 after event X. In one example, event Y is at a time-unit starting at or after a time T2 from event X. In one example, a time-unit is as mentioned herein. For example, a time-unit can be a slot or a sub-frame. In one example, event Y is the start of the channel activating subset S2 or indicating S3. In one example, event Y is the end of the channel activating subset S2 or indicating S3. In one example, event Y is the start of the channel activating subset S2 or indicating S3, and the channel is positively acknowledged. In one example, event Y is the end of the channel activating subset S2 or indicating S3, and the channel is positively acknowledged. In one example, event Y is the start of the channel carrying the acknowledgment (e.g., positive acknowledgement) of the channel activating subset S2 or indicating S3. In one example, event Y is the end of the channel carrying the acknowledgment (e.g., positive acknowledgement) of the channel activating subset S2 or indicating S3. In one example, T2 can be configured and/or updated by SIB signaling and/or RRC signaling and/or MAC CE signaling and/or L1 control (e.g., DCI) signaling.

In one example, at or after subset S2 has been activated or S3 has been applied, as illustrated in FIG. 26, a new S3 can be indicated from the most recently activated subset S2. In one example, event Z occurs at or after subset S2 is activated. In one example, event Z occurs at or after a time T3 from the time subset S2 is activated. In one example, event Z occurs at or after S3 is applied. In one example, event Z occurs at or after a time T3 from the time S3 is applied. In one example, event Z occurs at a time-unit boundary. In one example, a time-unit is as mentioned herein. For example, a time-unit can be a slot or a sub-frame. In one example, event Z is the start of the channel indicating new S3. In one example, event Z is the end of the channel indicating new S3. In one example, event Z is the start of the channel carrying the acknowledgment (e.g., positive acknowledgement) of the channel indicating new S3. In one example, event Z is the end of the channel carrying the acknowledgment (e.g., positive acknowledgement) of the channel indicating new S3. In one example, T3 can be configured and/or updated by SIB signaling and/or RRC signaling and/or MAC CE signaling and/or L1 control (e.g., DCI) signaling.

In one example, when subset S2 is activated, the currently applied spatial resource units or TCI states or reference signals, (S3) are included in subset S2.

In one example, when subset S2 is activated, at least one of the currently applied spatial resource units or TCI states or reference signals, (e.g., at least one of S3) is included in subset S2.

In one example, when subset S2 is activated, there is no restriction on subset S2 with regards to the currently applied S3.

In the following examples, a UE is configured/updated through higher layer RRC signaling a first set S11 of spatial resource units with L1 elements or a set S11 of TCI States with L1 elements or a set S11 of reference signals, e.g., for beam indication with L1 elements, and a second set S12 of spatial resource units with L1 elements or a set S12 of TCI States with L2 elements or a set S12 of reference signals, e.g., for beam indication with L2 elements. In one example, the first set can correspond to DL or joint beam indication and the second set can correspond to UL beam indication. In one example, the first set can correspond to a first entity (e.g., first TRP or a first cell or a first panel) and the second set can correspond to a second entity (e.g., second TRP or a second cell or a second panel).

In one example, A, a subset S2 of K elements is activated from set S11 and set S12. Where, elements of subset S2 can be activated spatial resource units or spatial resource unit code points or TCI states or TCI state code points or reference signals or reference signal code points from the set of L1 and L2 spatial resource units or the set of L1 and L2 TCI states or the set of L1 and L2 reference signal. In one example a code point in set S2 can include zero or one or more of: (1) element from set S11, (2) element from set S12, and (3) a pair including element from set S11 and element from set S12. In one example, subset S2 is referred to as a multi-variate TCI state (e.g., activated multi-variate TCI state (mv-TCI state)). A UE (e.g., the UE 116) is indicated M elements (denoted as S3) from subset S2. In one example, S3 is referred to as a multi-variate TCI state (e.g., indicated multi-variate TCI state (mv-TCI state)).

In one example, B, a subset S21 of K1 is activated from set S11, and a subset S22 of K2 elements is activated from set S12. Where, elements of subset S21 can be activated spatial resource units or spatial resource unit code points or TCI states or TCI state code points or reference signals or reference signal code points from the set of L1 spatial resource units or the set of L1 TCI states or the set of L1 reference signal. In one example, subset S21 is referred to as a multi-variate TCI state (e.g., first activated multi-variate TCI state (mv-TCI state)). Where, elements of subset S22 can be activated spatial resource units or spatial resource unit code points or TCI states or TCI state code points or reference signals or reference signal code points from the set of L2 spatial resource units or the set of L2 TCI states or the set of L2 reference signals. In one example, subset S22 is referred to as a multi-variate TCI state (e.g., second activated multi-variate TCI state (mv-TCI state)). In one example, subset S21 and S22 are referred to as a multi-variate TCI state (e.g., activated multi-variate TCI state (mv-TCI state)).
In one example, B1, a UE is indicated M elements (denoted as S3) from subset S21 and/or subset S22. An element of the M elements of S3 can be: (1) element from set S21, (2) element from set S22 or (3) a pair including element from set S21 and element from set S22. In one example, S3 is referred to as a multi-variate TCI state (e.g., indicated multi-variate TCI state (mv-TCI state)).
In one example, B2, a UE is indicated M1 elements (denoted as S31) from subset S21, M2 elements (denoted as S32). In one example, S31 is referred to as a multi-variate TCI state (e.g., first indicated multi-variate TCI state (mv-TCI state)), and S32 is referred to as a multi-variate TCI state (e.g., second indicated multi-variate TCI state (mv-TCI state)). In one example, S31 and S32 are referred to as a multi-variate TCI state (e.g., indicated multi-variate TCI state (my-TCI state)).

In one example, the activation of subset S2 or subsets S21 and S22 is by higher layer signaling, e.g., MAC CE signaling or RRC signaling. In one example, the activation of subset S2 or subsets S21 and S22 is by L1 control (e.g., DCI) signaling. In one example, the indication of S3 or the indication of S31 and S32 is by higher layer signaling, e.g., MAC CE signaling or RRC signaling. In one example, the indication of S3 or the indication of S31 and S32 is by L1 control (e.g., DCI) signaling. In one example, the activation of subset of subset S2 or subsets S21 and S22 and the indication of S3 or the indication of S31 and S32 are in a same signal. In one example, the activation of subset S2 or subsets S21 and S22 and the indication of S3 or the indication of S31 and S32 is by higher layer signaling, e.g., MAC CE signaling or RRC signaling. In one example, the activation of subset S2 or subsets S21 and S22 and the indication of S3 or the indication of S31 and S32 is by L1 control (e.g., DCI) signaling.

In one example, in the example A mentioned herein, a subset S2 of K elements is activated from set S11 and set S12 wherein an element in subset S2 includes a pair of elements a first element from the L1 elements of S11 and a second element from the L2 elements of S12. In one example, a set Sla contains the order pairs of pairs of elements from set S11 and from set S12. The size of Sla can be L1·L2 elements. In one example, a pair of elements with index l1a, can correspond to an element with index l1 from set S11 and an element with index l2 from set S12, such that

$$l 1 a = l 1 \cdot L 2 + l 2 , l 1 = ⌊ \frac{l 1 a}{L 2} ⌋ ,$$

and/or l2=l1a % L2, where % is the modulo operator (a=b % c, where a is the remainder of dividing b by c). In one example, a pair of elements with index l1a, can correspond to an element with index l1 from set S11 and an element with index l2 from set S12, such that

$$l 1 a = l 2 \cdot L 1 + l 1 , l 2 = ⌊ \frac{l 1 a}{L 1} ⌋ ,$$

and/or l1=l1a % L1.

In one example, a message activating subset S2 with size K elements—or up to K elements—where an element is a pair of elements from S11 and S12, can be according to the following examples:
Example 1: Include K fields corresponding to the K activated elements from set Sla. In one example, if the number of activated elements in subset S2 is less than K, one or more of the K elements of subset S2 is a special value indicating that the element is not activated.
Example 2: Include a field indicating a number of activated elements, and a list of activated elements (e.g., a corresponding index in set Sla). The number of elements in the list of activated elements can change depending on the number of activated elements.
Example 3: Include a field indicating a number of activated elements, and a list of K elements (e.g., a corresponding index in set Sla), wherein the list of K elements includes activated elements and remaining of the K elements can be assigned a special index indicating that the element is not used. The number of elements in the list of K elements can be fixed independent of the number of activated elements.
Example 4: A combinatorial index for K activated elements from set Sla as mentioned herein.
Example 5: Include a field indicating a number of activated elements and a combinatorial index corresponding to the activated elements as mentioned herein.
Example 6: A combinatorial index that indicates the number of activated elements and the combinatorial index for activated elements from set Sla with that number of activated elements. In one example, the first combinatorial indices (e.g., starting from 0) expect 1 activated element, the next combinatorial indices expect 2 activated elements, and so on until the combinatorial indices assuming K activated elements as mentioned herein. In one example, the first combinatorial indices (e.g., starting from 0) expect K activated elements, the next combinatorial indices expect K−1 activated elements, and so on until the combinatorial indices assuming 1 activated element as mentioned herein.

The examples mentioned herein (including examples on timing and restrictions on the activated elements) of activating K elements from S1a can follow the examples of activating K elements from S1, wherein set S1 is replaced by set S1a and L elements in set S1 are replaced by L elements, L=L1·L2, in set S1a.

In one example, in the example A mentioned herein, a subset S2 of K elements is activated from set S11 and set S12 wherein an element in subset S2 can include one of: (1) a pair of elements a first element from the L1 elements of S11 and a second element from the L2 elements of S12, or (2) an element from the L1 elements of S11 or (3) an element of the L2 elements of S12. In one example, a set S1b contains the order pairs of pairs of elements from set S11 and from set S12, and L1 elements of set S11, and L2 elements of set S12. The size of S1b can be L1·L2+L1+L2 elements. In one example, the elements can be arranged first the (L1·L2) pair of elements, then the L1 elements from S11, then the L2 elements from S12. In one example, the elements can be arranged first the (L1·L2) pair of elements, then the L2 elements from S12, then the L1 elements from S11. In one example, the elements can be arranged first the L1 elements from S11, then the L2 elements from S12, then the (L1·L2) pair of elements. In one example, the elements can be arranged first the L2 elements from S12, then the L1 elements from S11, then the (L1·L2) pair of elements. In one example, the elements can be arranged first the L1 elements from S11, then the (L1·L2) pair of elements, then the L2 elements from S12. In one example, the elements can be arranged first the L2 elements from S12, then the (L1·L2) pair of elements, then the L1 elements from S11.

To illustrate examples of indexing, the following two examples are evaluated:

In one example, the elements can be arranged first the (L1·L2) pair of elements, then the L1 elements from S11, then the L2 elements from S12. In one example, a pair of elements with index l1b, where l1b<L1·L2, can correspond to an element with index l1 from set S11 and an element with index l2 from set S12, such that

$$l 1 b = l 1 \cdot L 2 + l 2 , l 1 = ⌊ \frac{l 1 b}{L 2} ⌋ ,$$

and/or l2=l1b % L2, where % is the modulo operator (a=b % c, where a is the remainder of dividing b by c). In one example, a pair of elements with index l1b, where l1b<L1·L2, can correspond to an element with index l1 from set S11 and an element with index l2 from set S12, such that

$$l 1 b = l 2 \cdot L 1 + l 1 , l 2 = ⌊ \frac{l 1 b}{L 1} ⌋ ,$$

and/or l1=l1b % L1. An element with index l1b, where L1·L2≤l1b<L1·L2+L1, can correspond to an element with index l1 from set S11, such that l1b=l1+L1·L2. An element with index l1b, where L1·L2+L1≤l1b<L1·L2+L1+L2, can correspond to an element with index l2 from set S12, such that l1b=l2+L1·L2+L1.

In one example, the elements can be arranged first the L1 elements from S11, then the L2 elements from S12, then the (L1·L2) pair of elements. An element with index l1b, where l1b<L1, can correspond to an element with index l1 from set S11, such that l1b=l1. An element with index l1b, where L1≤l1b<L1+L2, can correspond to an element with index l2 from set S12, such that l1b=l2+L1. In one example, a pair of elements with index l1b, where L1+L2≤l1b<L1+L2+L1·L2, can correspond to an element with index l1 from set S11 and an element with index l2 from set S12, such that

$$l 1 b = L 1 + L 2 + l 1 \cdot L 2 + l 2 , l 1 = ⌊ \frac{l 1 b - L 1 - L 2}{L 2} ⌋ ,$$

and/or l2=(l1b−L1−L2) % L2, where % is the modulo operator (a=b % c, where a is the remainder of dividing b by c). In one example, a pair of elements with index l1b, where L1+L2≤l1b<L1+L2+L1·L2, can correspond to an element with index l1 from set S11 and an element with index l2 from set S12, such that

$$l 1 b = L 1 + L 2 + l 2 \cdot L 1 + l 1 , l 2 = ⌊ \frac{l 1 b - L 1 - L 2}{L 1} ⌋ ,$$

and/or l1=(l1b−L1−L2) % L1.

In one example, a message activating S2 with size K elements—or up to K elements—where an element is a pair of elements from S11 and S12 or an element from S11 or an element from S12, can be according to the following examples:
Example 1: Include K fields corresponding to the K activated elements from set S1b. In one example, if the number of activated elements in subset S2 is less than K, one or more of the K elements of subset S2 is a special value indicating that the element is not activated.
Example 2: Include a field indicating a number of activated elements, and a list of activated elements (e.g., a corresponding index in set S1b). The number of elements in the list of activated elements can change depending on the number of activated elements.
Example 3: Include a field indicating a number of activated elements, and a list of K elements (e.g., a corresponding index in set S1b), wherein the list of K elements includes activated elements and remaining of the K elements can be assigned a special index indicating that the element is not used. The number of elements in the list of K elements can be fixed independent of the number of activated elements.
Example 4: A combinatorial index for K activated elements from set S1b as mentioned herein.
Example 5: Include a field indicating a number of activated elements and a combinatorial index corresponding to the activated elements as mentioned herein.
Example 6: A combinatorial index that indicates that number of activated elements and the combinatorial index for activated elements from set S1b with that number of activated elements. In one example, the first combinatorial indices (e.g., starting from 0) expect 1 activated element, the next combinatorial indices expect 2 activated elements, and so on until the combinatorial indices assuming K activated elements as mentioned herein. In one example, the first combinatorial indices (e.g., starting from 0) expect K activated elements, the next combinatorial indices expect K−1 activated elements, and so on until the combinatorial indices assuming 1 activated element as mentioned herein.

The examples mentioned herein (including examples on timing and restrictions on the activated elements) of activating K elements from S1b can follow the examples of activating K elements from S1, wherein set S1 is replaced by set S1b and L elements in set S1 are replaced by L elements, L=L1·L2+L1+L2, in set S1b.

In one example, in the example A mentioned herein, a subset S2 of K elements is activated from set S11 and set S12 wherein an element in subset S2 can include one of: (1) a pair of elements a first element from the L1 elements of S11 and a second element from the L2 elements of S12, or (2) an element from the L1 elements of S11 or (3) an element of the L2 elements of S12. In one example, a set Sic contains the order pairs of pairs of elements from set S11+ and from set S12+. Where, set S11+ can include the elements of S11, and an additional element indicating no element of set S11 activated, for example the additional element can be added at the start of set S11 or at the end of set S11, denote this element as E1. Where, set S12+ can include the elements of S12, and an additional element indicating no element of set S12 activated, for example the additional element can be added at the start of set S12 or at the end of set S12, denote this element as E2. The ordered pair created from set S11+ and set S12+ can be one of the following:
Element from set S11 and element from set S12. This corresponds to a pair of elements from S11 and S12.
Element from set S11 and E2. This corresponds to an element from S11.
E1 and element from set S12. This corresponds to an element from S12.
E1 and E2. This corresponds to no activated elements. In one example, this element is removed from set S1c. In one example, this element is maintained in set S1c and can be used, for example, to signal an element in S2 not activated.

In one example, the size of S1c can be (L1+1)·(L2+1) elements, for example element corresponding to E1 and E2 is retained. In one example, the size of S1c can be (L1+1)·(L2+1)−1 elements, for example element corresponding to E1 and E2 is removed.

In one example, a pair of elements with index l1c, can correspond to an element with index l1p from set S11+ and an element with index l2p from set S12+ such that

$$l 1 c = l 1 p \cdot ( L 2 + 1 ) + l 2 p , l 1 p = ⌊ \frac{l 1 c}{L 2 + 1} ⌋ ,$$

and/or l2p=l1c % (L2+1), where % is the modulo operator (a=b % c, where a is the remainder of dividing b by c). In one example, a pair of elements with index l1c, can correspond to an element with index l1 from set S11+ and an element with index l2p from set S12+, such that

$$l 1 c = l 2 \cdot ( L 1 + 1 ) + l 1 , l 2 = ⌊ \frac{l 1 c}{L 1 + 1} ⌋ ,$$

and/or i1=l1c % (L1+1).

In one example, E1 is added at the end of S11 to get S11+, and E2 is added at the end of S12 to get S12+. If l1p<L1, l1p=11, if l1p=L1, this indicates element E1 from set S11+. If l2p<L2, l2p=12, if l2p=L2, this indicates element E2 from set S12+. In one example, the size of set S1c is (L1+1)(L2+1), element with index l1c=(L1+1)(L2+1)−1, indicates element with pair E1 and E2. In one example, the size of set S1c is (L1+1)(L2+1)−1, there is no element with index l1c=(L1+1)(L2+1)−1, element indicating pair E1 and E2 is removed.

In one example, E1 is added at the start of S11 to get S11+, and E2 is added at the start of S12 to get S12+. If l1p=0, this indicates element E1 from set S11+, if l1p>0, l1p=1i+1. If l2p=0, this indicates element E2 from set S12+, if l2p>0, l2p=l2+1. In one example, the size of set S1c is (L1+1)(L2+1), element with index l1c=0, indicates element with pair E1 and E2. In one example, the size of set S1c is (L1+1)(L2+1)−1, there is no element with index l1c=0, element indicating pair E1 and E2 is removed. In one example, the size of set S1c is (L1+1)(L2+1)−1, there is no element pair E1 and E2 (it is removed). Index l1c is adjusted by subtracting one, e.g., this corresponds to removed element with lp1=0 and lp2=0. According to the examples mentioned herein, l1c=l1p·(L2+1)+l2p−1, or l1c=l2·(L1+1)+l1−1.

In one example, a message activating S2 with size K elements—or up to K elements—where an element is a pair of elements from S11+ and S12+ (this can correspond to is a pair of elements from S11 and S12 or an element from S11 or an element from S12 and an empty element (pair E1 and E2)), can be according to the following examples:
Example 1: Include K fields corresponding to the K activated elements from set S1c. In one example, if the number of activated elements in subset S2 is less than K, one or more of the K elements of subset S2 is a special value (e.g., the special value can be pair (E1,E2)) indicating that the element is not activated.
Example 2: Include a field indicating a number of activated elements, and a list of activated elements (e.g., a corresponding index in set S1c). The number of elements in the list of activated elements can change depending on the number of activated elements.
Example 3: Include a field indicating a number of activated elements, and a list of K elements (e.g., a corresponding index in set S1c), wherein the list of K elements includes activated elements and remaining of the K elements can be assigned a special index indicating that the element is not used (e.g., indicating a pair E1 and E2 according to the examples mentioned herein). The number of elements in the list of K elements can be fixed independent of the number of activated elements.
Example 4: A combinatorial index for K activated elements from set S1c as mentioned herein.
Example 5: a field indicating a number of activated elements and a combinatorial index corresponding to the activated elements as mentioned herein.
Example 6: A combinatorial index that indicates that number of activated elements and the combinatorial index for activated elements from set S1c with that number of activated elements. In one example, the first combinatorial indices (e.g., starting from 0) expect 1 activated element, the next combinatorial indices expect 2 activated elements, and so on until the combinatorial indices assuming K activated elements as mentioned herein. In one example, the first combinatorial indices (e.g., starting from 0) expect K activated elements, the next combinatorial indices expect K−1 activated elements, and so on until the combinatorial indices assuming 1 activated element as mentioned herein.

The examples mentioned herein (including examples on timing and restrictions on the activated elements) of activating K elements from S1c can follow the examples of activating K elements from S1, wherein set S1 is replaced by set Sic and L elements in set S1 are replaced by L elements, L=(L1+1)·(L2+1) or L=(L1+1)·(L2+1)−1 (as described herein), in set S1c.

In one example, in the example A mentioned herein, a subset S2 of K elements is activated from set S11 and set S12 wherein an element in subset S2 can include one of: (1) a pair of elements a first element from the L1 elements of S11 and a second element from the L2 elements of S12, or (2) an element from the L1 elements of S11 or (3) an element of the L2 elements of S12. In one example, three sets of values are signaled for subset S2. The first set of values indicating elements from set Sla, which contains the order pairs of elements from set S11 and from set S12. The second set of values indicating elements from set S11. The third set of values indicating elements from set S12. The size of Sla can be L1·L2 elements. In one example, a pair of elements with index l1a, can correspond to an element with index l1 from set S11 and an element with index l2 from set S12 such that

$$l 1 a = l 1 \cdot L 2 + l 2 , l 1 = ⌊ \frac{l 1 a}{L 2} ⌋ ,$$

and/or l2=l1a % L2, where % is the modulo operator (a=b % c, where a is the remainder of dividing b by c). In one example, a pair of elements with index l1a, can correspond to an element with index l1 from set S11 and an element with index l2 from set S12, such that

$$l 1 a = l 2 \cdot L 1 + l 1 , l 2 = ⌊ \frac{l 1 a}{L 1} ⌋ ,$$

and/or l1=l1a % L1.

In one example, a message activating S2 with size K elements—or up to K elements—where an element is a pair of elements from S11 and S12, or an element from S11 or an element from S12 can be according to the following examples:
Example 1: Include (1) a field indicating a number of activated elements from set Sla, and a list of activated elements from set S1a (e.g., a corresponding index in set S1a), and (2) a field indicating a number of activated elements from set S11, and a list of activated elements from set S11 (e.g., a corresponding index in set S11), and (3) a field indicating a number of activated elements from set S12, and a list of activated elements from set S12 (e.g., a corresponding index in set S12). The number of elements in each list of activated elements can change depending on the number of corresponding activated elements.
Example 2: Include (1) a field indicating a number of activated elements from set S1a and a combinatorial index corresponding to the activated elements from set S1 a as mentioned herein, (2) a field indicating a number of activated elements from set S11 and a combinatorial index corresponding to the activated elements from set S11 as mentioned herein, and (3) a field indicating a number of activated elements from set S12 and a combinatorial index corresponding to the activated elements from set S12 as mentioned herein.
Example 3: Included (1) a combinatorial index that indicates the number of activated elements and the combinatorial index for activated elements from set S1a with that number of activated elements, and (2) a combinatorial index that indicates the number of activated elements and the combinatorial index for activated elements from set S11 with that number of activated elements, and (3) a combinatorial index that indicates the number of activated elements and the combinatorial index for activated elements from set S12 with that number of activated elements. In one example, the first combinatorial indices (e.g., starting from 0) expect 1 activated element, the next combinatorial indices expect 2 activated elements, and so on until the combinatorial indices assuming K activated elements as mentioned herein. In one example, the first combinatorial indices (e.g., starting from 0) expect K activated elements, the next combinatorial indices expect K−1 activated elements, and so on until the combinatorial indices assuming 1 activated element as mentioned herein.

The examples mentioned herein (including examples on timing and restrictions on the activated elements) of activating K elements from S1a/S11/S12 can follow the examples of activating K elements from S1, wherein set S1 is replaced by set S1a/S11/S12 and L elements in set S1 are replaced by L elements, L=L1·L2 or L=L1 or L=L2, in set S1a/S11/S12 respectively.

In one example, in the example A mentioned herein, a subset S2 of K elements is activated from set S11 and set S22 wherein an element in subset S2 can include one of: (1) a pair of elements a first element from the L1 elements of S11 and a second element from the L2 elements of S12, or (2) an element from the L1 elements of S11 or (3) an element of the L2 elements of S12. In one example, two sets of values are signaled for subset S2. The first set of values indicating elements from set S1a, which contains the order pairs of elements from set S11 and from set S12. The second set of values indicating elements from a set S1 d, which contains the elements of S11 and S12, with a size L=L1+L2. The size of S1a can be L1·L2 elements. The size of S1d can be L1+L2 elements. In one example, a pair of elements with index l1a, can correspond to an element with index l1 from set S11 and an element with index l2 from set S12, such that

$$l 1 a = l 1 \cdot L 2 + l 2 , l 1 = ⌊ \frac{l 1 a}{L 2} ⌋ ,$$

and/or l2=l1a % L2, where % is the modulo operator (a=b % c, where a is the remainder of dividing b by c). In one example, a pair of elements with index l1a, can correspond to an element with index l1 from set S11 and an element with index l2 from set S12, such that

$$l 1 a = l 2 \cdot L 1 + l 1 , l 2 = ⌊ \frac{l 1 a}{L 1} ⌋ ,$$

and/or l1=l1a % L1. In one example, an element with index l1d from set S1d, can correspond to an element with index l1 from set S11 or an element with index l2 from set S12, such that if element is from set S11, l1d<L1, and l1d=l1, and if element is from set S12, l1d≥L1, and l1d=L1+l2. In one example, an element with index l1d from set S1d, can correspond to an element with index l1 from set S11 or an element with index l2 from set S12, such that if element is from set S11, l1d≥L2, and l1d=L2+l1, and if element is from set S12, l1d<L2, and l1d=l2.

In one example, a message activating S2 with size K elements—or up to K elements—where an element is a pair of elements from S11 and S12, or an element from S11 or an element from S12, can be according to the following examples:
Example 1: Include (1) a field indicating a number of activated elements from set S1a, and a list of activated elements from set S1a (e.g., a corresponding index in set S1a), and (2) a field indicating a number of activated elements from set S1d, and a list of activated elements from set S1d (e.g., a corresponding index in set S1d). The number of elements in each list of activated elements can change depending on the number of corresponding activated elements.
Example 2: Include (1) a field indicating a number of activated elements from set S1a and a combinatorial index corresponding to the activated elements from set S1 a as mentioned herein, and (2) a field indicating a number of activated elements from set S1d and a combinatorial index corresponding to the activated elements from set S1d as mentioned herein.
Example 3: Included (1) a combinatorial index that indicates that number of activated elements and the combinatorial index for activated elements from set S1a with that number of activated elements, and (2) a combinatorial index that indicates that number of activated elements and the combinatorial index for activated elements from set S1d with that number of activated elements. In one example, the first combinatorial indices (e.g., starting from 0) expect 1 activated element, the next combinatorial indices expect 2 activated elements, and so on until the combinatorial indices assuming K activated elements as mentioned herein. In one example, the first combinatorial indices (e.g., starting from 0) expect K activated elements, the next combinatorial indices expect K−1 activated elements, and so on until the combinatorial indices assuming 1 activated element as mentioned herein.

The examples mentioned herein (including examples on timing and restrictions on the activated elements) of activating K elements from S1a/S1d can follow the examples of activating K elements from S1, wherein set S1 is replaced by set S1a/S1d and L elements in set S1 are replaced by L elements, L=L1·L2 or L=L1+L2, in set S1a/S1d respectively.

According to previous examples, the message for activating K elements of subset S2 can be single part message or a two-part message, with a first part and a second part. In one example, the first part can include information to indicate a size or length of a second part. In one example, a first part can include a field indicating a number of activated elements, wherein the number of activated elements can be for set S1a and/or for set S1b and/or for set Sic and/or for set S11 and/or for set S12 and/or for set S1d according to the examples mentioned herein. In one example, the first part can include or indicate zero one or more of activated elements from set S1a and/or from set S1b and/or from set Sic and/or from set S11 and/or from set S12 and/or from set S1d. The second part indicates the activated TCI states (TCI state code points) as a list or a combinatorial index as aforementioned.

In one example, in the example A mentioned herein, after a subset S2 with K elements is activated, M elements in S3 are indicated. The indication of M elements in S3 from K elements in subset S2 can be according to the examples mentioned herein.

In one example, in the example A mentioned herein, a message can activate a subset S2 with K elements, and indicate S3 with M elements from the K elements of subset S2. The activation of subset S2 is according to the examples mentioned herein of example A. The indication of S3 with M elements is according to the examples mentioned herein.

In one example, in the example B mentioned herein, a first subset S21 of K1 elements is activated from the elements of set S11, and a second subset S22 of K2 elements is activated from the elements of set S12. The activation of subset S21 and of subset S22, follows the examples mentioned herein of activation of subset S2 from set S1, where set S1 is replaced by set S11 or set S12, subset S2 is replaced by subset S21 or subset S22, L elements in set S1 is replaced by L1 elements in set S11 or L2 elements in set S12, and K elements in subset S2 is replaced by K1 elements in subset S21 or K2 elements in subset S22.

In one example, the activation of subset S21 and subset S22 are in a same message. In one example, the message has a single part. In one example, the message has two parts a first part and a second part. In one example, the activation of subset S21 and subset S22 can be in different messages. In one example, the message for the activation of S21 or the message for the activation of S22 has a single part. In one example, the message for the activation of S21 or the message for the activation of S22 has two parts a first part and a second part.

In one example, in the example B1 mentioned herein, S3 of M elements is indicated from subset S21 and subset S22 wherein an element in S3 includes a pair of elements a first element from the K1 elements of S21 and a second element from the L2 elements of S22. In one example, a subset S2a contains the order pairs of pairs of elements from subset S21 and from subset S22. The size of S2a can be K1·K2 elements. In one example, a pair of elements with index k2a, can correspond to an element with index k1 from subset S21 and an element with index k2 from set S22, such that

$$k 2 a = k 1 \cdot K 2 + k 2 , k 1 = ⌊ \frac{k 2 a}{K 2} ⌋ ,$$

and/or k2=k2a % K2, where % is the modulo operator (a=b % c, where a is the remainder of dividing b by c). In one example, a pair of elements with index k2a, can correspond to an element with index k1 from subset S21 and an element with index k2 from subset S22, such that

$$k 2 a = k 2 \cdot K 1 + k 1 , k 2 = ⌊ \frac{k 2 a}{K 1} ⌋ ,$$

and/or k1=k2a % K1.

In one example, a message indicating S3 with size M elements—or up to M elements—where an element is a pair of elements from S21 and S22, can be according to the following examples:
Example 1: Include M fields corresponding to the M indicated elements from subset S2a. In one example, if the number of indicated elements is less than M, one or more of the M elements of S3 is a special value indicating that the element is not indicated.
Example 2: Include a field indicating a number of indicated elements, and a list of indicated elements (e.g., a corresponding index in set S2a). The number of elements in the list of indicated elements can change depending on the number of indicated elements.
Example 3: Include a field indicating a number of indicated elements, and a list of M elements (e.g., a corresponding index in set S2a), wherein the list of M elements includes indicated elements and remaining of the M elements can be assigned a special index indicating that the element is not used. The number of elements in the list of M elements can be fixed independent of the number of indicated elements.
Example 4: A combinatorial index for M indicated elements from subset S2a as mentioned herein.
Example 5: Include a field indicating a number of indicated elements and a combinatorial index corresponding to the indicated elements as mentioned herein.
Example 6: A combinatorial index that indicates the number of indicated elements and the combinatorial index for indicated elements from subset S2a with that number of indicated elements. In one example, the first combinatorial indices (e.g., starting from 0) expect 1 indicated element, the next combinatorial indices expect 2 indicated elements, and so on until the combinatorial indices assuming M indicated elements as mentioned herein. In one example, the first combinatorial indices (e.g., starting from 0) expect M indicated elements, the next combinatorial indices expect M−1 indicated elements, and so on until the combinatorial indices assuming 1 indicated element as mentioned herein.

The examples mentioned herein (including examples on timing) of indicating M elements from S2a can follow the examples of indicating M elements from S2, wherein subset S2 is replaced by subset S2a and K elements in subset S2 are replaced by K elements, K=K1·K2, in subset S2a.

In one example, in the example B1 mentioned herein, S3 of M elements is indicated from subset S21 and subset S22 wherein an element in S3 can include one of: (1) a pair of elements a first element from the K1 elements of S21 and a second element from the K2 elements of S22, or (2) an element from the K1 elements of S21 or (3) an element of the K2 elements of S22. In one example, a set S2b contains the order pairs of pairs of elements from subset S21 and from subset S22, and K1 elements of subset S21, and K2 elements of subset S22. The size of S2b can be K1·K2+K1+K2 elements. In one example, the elements can be arranged first the (K1·K2) pair of elements, then the K1 elements from S21, then the K2 elements from S22. In one example, the elements can be arranged first the (K1·K2) pair of elements, then the K2 elements from S22, then the K1 elements from S21. In one example, the elements can be arranged first the K1 elements from S21, then the K2 elements from S22, then the (K1·K2) pair of elements. In one example, the elements can be arranged first the K2 elements from S22, then the K1 elements from S21, then the (K1·K2) pair of elements. In one example, the elements can be arranged first the K1 elements from S21, then the (K1·K2) pair of elements, then the K2 elements from S22. In one example, the elements can be arranged first the K2 elements from S22, then the (K1·K2) pair of elements, then the K1 elements from S21.

To illustrate examples of indexing, the following two examples are evaluated:

In one example, the elements can be arranged first the (K1·K2) pair of elements, then the K1 elements from S21, then the K2 elements from S22. In one example, a pair of elements with index k2b, where k2b<K1·K2, can correspond to an element with index k1 from set S21 and an element with index k2 from set S22, such that

$$k 2 b = k 1 \cdot K 2 + k 2 , k 1 = ⌊ \frac{k 2 b}{K 2} ⌋ ,$$

and/or k2=k2b % K2, where % is the modulo operator (a=b % c, where a is the remainder of dividing b by c). In one example, a pair of elements with index k2b, where k2b<K1·K2, can correspond to an element with index k1 from subset S21 and an element with index k2 from subset S22, such that

$$k 2 b = k 2 \cdot K 1 + k 1 , k 2 = ⌊ \frac{k 2 b}{K 1} ⌋ ,$$

and/or k1=k2b % K1. An element with index k2b, where K1·K2≤k2b<K1·K2+K1, can correspond to an element with index k1 from subset S21, such that k2b=k1+K1·K2. An element with index k2b, where K1·K2+K1≤k2b<K1·K2+K1+K2, can correspond to an element with index k2 from set S22, such that k2b=k2+K1·K2+K1.

In one example, the elements can be arranged first the K1 elements from S21, then the K2 elements from S22, then the (K1·K2) pair of elements. An element with index k2b, where k2b<K1, can correspond to an element with index k1 from subset S21, such that k2b=k1. An element with index k2b, where K1≤k2b<K1+K2, can correspond to an element with index k2 from subset S22, such that k2b=k2+K1. In one example, a pair of elements with index k2b, where K1+K2≤k2b<K1+K2+K1·K2, can correspond to an element with index k1 from subset S21 and an element with index k2 from subset S22, such that

$$k 2 b = K 1 + K 2 + k 1 \cdot K 2 + k 2 , k 1 = ⌊ \frac{k 2 b - K 1 - K 2}{K 2} ⌋ ,$$

and/or k2=(k2b−K1−K2) % K2, where % is the modulo operator (a=b % c, where a is the remainder of dividing b by c). In one example, a pair of elements with index k2b, where K1+K2≤k2b<K1+K2+K1·K2, can correspond to an element with index k1 from sunset S21 and an element with index k2 from subset S22, such that

$$k 2 b = K 1 + K 2 + k 2 \cdot K 1 + k 1 , k 2 = ⌊ \frac{k 2 b - K 1 - K 2}{K 1} ⌋ ,$$

and/or k1=(k2b−K1−K2) % K1.

In one example, a message indicating S3 with size M elements—or up to M elements—where an element is a pair of elements from S21 and S22 or an element from S21 or an element from S22, can be according to the following examples:
Example 1: Include M fields corresponding to the M activated elements from set S2b. In one example, if the number of indicated elements is less than M, one or more of the M elements of S3 is a special value indicating that the element is not indicated.
Example 2: Include a field indicating a number of indicated elements, and a list of indicated elements (e.g., a corresponding index in set S2b). The number of elements in the list of indicated elements can change depending on the number of indicated elements.
Example 3: Include a field indicating a number of indicated elements, and a list of M elements (e.g., a corresponding index in set S2b), wherein the list of M elements includes indicated elements and remaining of the M elements can be assigned a special index indicating that the element is not used. The number of elements in the list of M elements can be fixed independent of the number of indicated elements.
Example 4: A combinatorial index for M activated elements from set S2b as mentioned herein.
Example 5: Include a field indicating a number of indicated elements and a combinatorial index corresponding to the indicated elements as mentioned herein.
Example 6: A combinatorial index that indicates that number of indicated elements and the combinatorial index for indicated elements from set S2b with that number of indicated elements. In one example, the first combinatorial indices (e.g., starting from 0) expect 1 indicated element, the next combinatorial indices expect 2 indicated elements, and so on until the combinatorial indices assuming M indicated elements as mentioned herein. In one example, the first combinatorial indices (e.g., starting from 0) expect M indicated elements, the next combinatorial indices expect M−1 indicated elements, and so on until the combinatorial indices assuming 1 indicated element as mentioned herein.

The examples mentioned herein (including examples on timing) of indicating M elements from S2b can follow the examples of activating M elements from S2, wherein set S2 is replaced by set S2b and K elements in subset S2 are replaced by K elements, K=K1·K2+K1+K2, in set S2b.

In one example, in the example B1 mentioned herein, S3 of M elements is indicated from subset S21 and subset S22 wherein an element in S3 can include one of: (1) a pair of elements a first element from the K1 elements of S21 and a second element from the K2 elements of S22, or (2) an element from the K1 elements of S21 or (3) an element of the K2 elements of S22. In one example, a set S2c contains the order pairs of pairs of elements from subset S21+ and from subset S22+. Subset S21+ can include the elements of S21, and an additional element indicating no element of subset S21 indicated, for example the additional element can be added at the start of subset S21 or at the end of subset S21, denote this element as E1. Subset S22+ can include the elements of S22, and an additional element indicating no element of subset S22 activated, for example the additional element can be added at the start of subset S22 or at the end of subset S22, denote this element as E2. The ordered pair created from subset S21+ and subset S22+ can be one of the following:
Element from subset S21 and element from subset S22. This corresponds to a pair of elements from S21 and S22.
Element from subset S21 and E2. This corresponds to an element from S21.
E1 and element from subset S22. This corresponds to an element from S22.
E1 and E2. This corresponds to no activated elements. In one example, this element is removed from subset S2c. In one example, this element is maintained in subset S2c and can be used, for example, to signal an element in S3 not indicated.

In one example, the size of S2c can be (K1+1)·(K2+1) elements, for example element corresponding to E1 and E2 is retained. In one example, the size of S2c can be (K1+1)·(K2+1)−1 elements, for example element corresponding to E1 and E2 is removed.

In one example, a pair of elements with index k2c, can correspond to an element with index k1p from subset S21+ and an element with index k2p from subset S22+, such that

$$k 2 c = k 1 p \cdot ( K 2 + 1 ) + k 2 p , k 1 p = ⌊ \frac{k 2 c}{K 2 + 1} ⌋ ,$$

and/or k2p k2c % (K2+1), where % the modulo operator (a=b % c, where a is the remainder of dividing b by c). In one example, a pair of elements with index k2c, can correspond to an element with index k1p from subset S21+ and an element with index k2p from subset S22+, such that

$$k 2 c = k 2 \cdot ( K 1 + 1 ) + k 1 , k 2 = ⌊ \frac{k 2 c}{K 1 + 1} ⌋ ,$$

and/or k1=k2c % (K1+1).

In one example, E1 is added at the end of S21 to get S21+, and E2 is added at the end of S22 to get S22+. If k1p<K1, kp=k1, if kp=K1, this indicates element E1 from subset S21+. If k2p<K2, k2p=k2, if k2p=K2, this indicates element E2 from subset S22+. In one example, the size of subset S2c is (K1+1)(K2+1), element with index k2c=(K1+1)(K2+1)−1, indicates element with pair E1 and E2. In one example, the size of set S2c is (K1+1)(K2+1)−1, there is no element with index k2c=(K1+1)(K2+1)−1, element indicating pair E1 and E2 is removed.

In one example, E1 is added at the start of S21 to get S21+, and E2 is added at the start of S22 to get S22+. If kp=0, this indicates element E1 from subset S21+, if k1p>0, k1p=k1+1. If k2p=0, this indicates element E2 from subset S22+, if k2p>0, k2p=k2+1. In one example, the size of set S2c is (K1+1)(K2+1), element with index k2c=0, indicates element with pair E1 and E2. In one example, the size of set S2c is (K1+1)(K2+1)−1, there is no element with index k2c=0, element indicating pair E1 and E2 is removed. In one example, the size of set S2c is (K1+1)(K2+1)−1, there is no element pair E1 and E2 (it is removed). Index sk2c is adjusted by subtracting one, e.g., this corresponds to removed element with kp1=0 and kp2=0. According to the examples mentioned herein, k2c=k1p·(k2+1)+k2p−1, or k2c=k2·(K1+1)+k1−1.

In one example, a message indicating S3 with size M elements—or up to M elements—where an element is a pair of elements from S21+ and S22+(this can correspond to is a pair of elements from S21 and S22 or an element from S21 or an element from S22 and an empty element (pair E1 and E2)), can be according to the following examples:
Example 1: Include M fields corresponding to the M indicated elements from set S2c. In one example, if the number of indicated elements is less than M, one or more of the M elements of S3 is a special value (e.g., the special value can be pair (E1,E2)) indicating that the element is not indicated.
Example 2: Include a field indicating a number of indicated elements, and a list of indicated elements (e.g., a corresponding index in set S2c). The number of elements in the list of indicated elements can change depending on the number of indicated elements.
Example 3: Include a field indicating a number of indicated elements, and a list of M elements (e.g., a corresponding index in subset S2c), wherein the list of M elements includes indicated elements and remaining of the M elements can be assigned a special index indicating that the element is not used (e.g., indicating a pair E1 and E2 according to the examples mentioned herein). The number of elements in the list of M elements can be fixed independent of the number of indicated elements.
Example 4: A combinatorial index for M indicated elements from set S2c as mentioned herein.
Example 5: a field indicating a number of indicated elements and a combinatorial index corresponding to the indicated elements as mentioned herein.
Example 6: A combinatorial index that indicates that number of indicated elements and the combinatorial index for indicated elements from subset S2c with that number of indicated elements. In one example, the first combinatorial indices (e.g., starting from 0) expect 1 indicated element, the next combinatorial indices expect 2 indicated elements, and so on until the combinatorial indices assuming M indicated elements as mentioned herein. In one example, the first combinatorial indices (e.g., starting from 0) expect M indicated elements, the next combinatorial indices expect M−1 indicated elements, and so on until the combinatorial indices assuming 1 indicated element as mentioned herein.

The examples mentioned herein (including examples on timing) of indicating M elements from S2c can follow the examples of indicating M elements from S2, wherein subset S2 is replaced by subset S2c and K elements in subset S2 are replaced by K elements, K=(K1+1)·(K2+1) or K=(K1+1)·(K2+1)−1 (as described herein), in subset S2c.

In one example, in the example B1 mentioned herein, S3 of M elements is indicated from subset S21 and S22 wherein an element in S3 can include one of: (1) a pair of elements a first element from the K1 elements of S21 and a second element from the K2 elements of S22, or (2) an element from the K1 elements of S21 or (3) an element of the K2 elements of S22. In one example, three sets of values are signaled for S3. The first set of values indicating elements from subset S2a, which contains the order pairs of elements from set S21 and from set S22. The second set of values indicating elements from subset S21. The third set of values indicating elements from subset S22. The size of S2a can be K1·K2 elements. In one example, a pair of elements with index k2a, can correspond to an element with index k1 from subset S21 and an element with index k2 from subset S22, such that

$$k 2 a = k 1 \cdot K 2 + k 2 , k 1 = ⌊ \frac{k 2 a}{K 2} ⌋ ,$$

and/or k2=k2a % K2, where % is the modulo operator (a=b % c, where a is the remainder of dividing b by c). In one example, a pair of elements with index k2a, can correspond to an element with index k1 from subset S21 and an element with index k2 from subset S22, such that

$$k 2 a = k 2 \cdot K 1 + k 1 , k 2 = ⌊ \frac{k 2 a}{K 1} ⌋ ,$$

and/or k1 k2a % K1.

In one example, a message indicating S3 with size M elements—or up to M elements—where an element is a pair of elements from S21 and S22, or an element from S21 or an element from S22, can be according to the following examples:
Example 1: Include (1) a field indicating a number of indicated elements from subset S2a, and a list of indicated elements from subset S2a (e.g., a corresponding index in subset S2a), and (2) a field indicating a number of indicated elements from subset S21, and a list of indicated elements from subset S21 (e.g., a corresponding index in subset S21), and (3) a field indicating a number of indicated elements from subset S22, and a list of indicated elements from subset S22 (e.g., a corresponding index in subset S22). The number of elements in each list of indicated elements can change depending on the number of corresponding indicated elements.
Example 2: Include (1) a field indicating a number of indicated elements from subset S2a and a combinatorial index corresponding to the indicated elements from subset S2a as mentioned herein, (2) a field indicating a number of indicated elements from subset S21 and a combinatorial index corresponding to the indicated elements from subset S21 as mentioned herein, and (3) a field indicating a number of indicated elements from subset S22 and a combinatorial index corresponding to the indicated elements from subset S22 as mentioned herein.
Example 3: Included (1) a combinatorial index that indicates the number of indicated elements and the combinatorial index for indicated elements from subset S2a with that number of indicated elements, and (2) a combinatorial index that indicates the number of indicated elements and the combinatorial index for indicated elements from subset S21 with that number of indicated elements, and (3) a combinatorial index that indicates the number of indicated elements and the combinatorial index for indicated elements from subset S22 with that number of indicated elements. In one example, the first combinatorial indices (e.g., starting from 0) expect 1 indicated element, the next combinatorial indices expect 2 indicated elements, and so on until the combinatorial indices assuming M indicated elements as mentioned herein. In one example, the first combinatorial indices (e.g., starting from 0) expect M indicated elements, the next combinatorial indices expect M−1 indicated elements, and so on until the combinatorial indices assuming 1 indicated element as mentioned herein.

The examples mentioned herein (including examples on timing) of indicating M elements from S2a/S21/S22 can follow the examples of indicating M elements from S2, wherein subset S2 is replaced by subset S2a/S21/S22 and K elements in subset S2 are replaced by K elements, K=K1 K2 or K=K1 or K=K2, in subset S2a/S21/S22 respectively.

In one example, in the example B1 mentioned herein, S3 of M elements is indicated from subset S21 and subset S22 wherein an element in S3 can include one of: (1) a pair of elements a first element from the K1 elements of S21 and a second element from the K2 elements of S22, or (2) an element from the K1 elements of S21 or (3) an element of the K2 elements of S22. In one example, two sets of values are signaled for S3. The first set of values indicating elements from subset S2a, which contains the order pairs of elements from subset S21 and from subset S22. The second set of values indicating elements from a subset S2d, which contains the elements of S21 and S22, with a size K=K1+K2. The size of S2a can be K1·K2 elements. The size of S2d can be K1+K2 elements. In one example, a pair of elements with index k2a, can correspond to an element with index k1 from subset S21 and an element with index k2 from subset S22, such that

$$k 2 a = k 1 \cdot K 2 + k 2 , k 1 = ⌊ \frac{k 2 a}{K 2} ⌋ ,$$

and/or k2=k2a % K2, where % is the modulo operator (a=b % c, where a is the remainder of dividing b by c). In one example, a pair of elements with index k2a, can correspond to an element with index k1 from subset S21 and an element with index k2 from subset S22, such that

$$k 2 a = k 2 \cdot K 1 + k 1 , k 2 = ⌊ \frac{k 2 a}{K 1} ⌋ ,$$

and/or k1=k2a % K1. In one example, an element with index k2d from set S2d, can correspond to an element with index k1 from subset S21 or an element with index k2 from subset S22, such that if element is from subset S21, k2d<K1, and k2d=k1, and if element is from subset S22, k2d≥K1, and k2d=K1+k2. In one example, an element with index k2d from subset S2d, can correspond to an element with index k1 from subset S21 or an element with index k2 from subset S22, such that if element is from subset S21, k2d≥K2, and k2d=K2+k1, and if element is from subset S22, k2d<K2, and l1d=l12.

In one example, a message indicating S3 with size M elements—or up to M elements—where an element is a pair of elements from S11 and S12, or an element from S21 or an element from S22, can be according to the following examples:
Example 1: Include (1) a field indicating a number of indicated elements from subset S2a, and a list of indicated elements from subset S2a (e.g., a corresponding index in subset S2a), and (2) a field indicating a number of indicated elements from subset S2d, and a list of indicated elements from subset S2d (e.g., a corresponding index in subset S2d). The number of elements in each list of indicated elements can change depending on the number of corresponding indicated elements.
Example 2: Include (1) a field indicating a number of indicated elements from subset S2a and a combinatorial index corresponding to the indicated elements from subset S2a as mentioned herein, and (2) a field indicating a number of indicated elements from subset S2d and a combinatorial index corresponding to the indicated elements from subset S2d as mentioned herein.
Example 3: Included (1) a combinatorial index that indicates that number of indicated elements and the combinatorial index for indicated elements from subset S2a with that number of indicated elements, and (2) a combinatorial index that indicates that number of indicated elements and the combinatorial index for indicated elements from subset S2d with that number of indicated elements. In one example, the first combinatorial indices (e.g., starting from 0) expect 1 indicated element, the next combinatorial indices expect 2 indicated elements, and so on until the combinatorial indices assuming M indicated elements as mentioned herein. In one example, the first combinatorial indices (e.g., starting from 0) expect M indicated elements, the next combinatorial indices expect M−1 indicated elements, and so on until the combinatorial indices assuming 1 indicated element as mentioned herein.

The examples mentioned herein (including examples on timing) of indicating M elements from S2a/S2d can follow the examples of indicating M elements from S2, wherein subset S2 is replaced by subset S2a/S2d and K elements in subset S2 are replaced by K elements, K=K1·K2 or K=K1+K2, in subset S2a/S2d respectively.

According to previous examples, the message for indicating M elements of S3 can be single part message or a two-part message, with a first part and a second part. In one example, the first part can include information to indicate a size or length of a second part. In one example, a first part can include a field indicating a number of indicated elements, wherein the number of indicated elements can be for subset S2a and/or for subset S2b and/or for subset S2c and/or for subset S21 and/or for subset S22 and/or for subset S2d according to the examples mentioned herein. In one example, the first part can include or indicate zero one or more of indicated elements from subset S2a and/or from subset S2b and/or from subset S2c and/or from subset S21 and/or from subset S22 and/or from subset S2d.

In one example, in the mentioned herein example B2, a first list S31 of M1 elements is indicated from the elements of subset S21, and a second list S32 of M2 elements is indicated from the elements of subset S32. The indication of list S31 and of list S32, follows the examples mentioned herein of indication of S3 from subset S2, where subset S2 is replaced by subset S21 or subset S22, S3 is replaced by S31 or S32, K elements in subset S2 is replaced by K1 elements in subset S21 or K2 elements in subset S22, and M elements in S3 is replaced by M1 elements in S31 or M2 elements in S32.

In one example, the indication of S31 and S32 are in a same message. In one example, the message has a single part. In one example, the message has two parts a first part and a second part. In one example, the indication of S31 and S32 can be in different messages. In one example, the message for the indication of S31 or the message for the indication of S32 has a single part. In one example, the message for the indication of S31 or the message for the indication of S32 has two parts a first part and a second part.

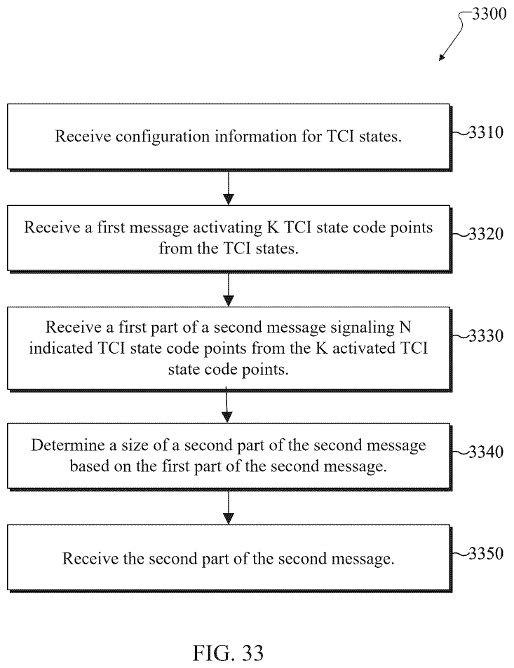

FIG. 33 illustrates an example method 3300 performed by a UE in a wireless communication system according to embodiments of the present disclosure. The method 3300 of FIG. 33 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3300 is for illustration only and other embodiments can be used without departing from the scope of the present disclosure.

The method 3300 begins with the UE receiving configuration information for TCI states (3310). The UE then receives a first message activating K TCI state code points from the TCI states (3310). For example, in 3310, K is a positive integer. In various embodiments, the first message includes a first part and a second part, the first part of the first message and the first part of the second message are received in a first channel, and the second part of the first message and the second part of the second message are received in a second channel.

The UE then receives a first part of a second message signaling N indicated TCI state code points from the K activated TCI state code points (3330). For example, in 3330, N is a positive integer. In various embodiments, the N indicated TCI state code points are provided by a combinatorial index across the K activated TCI state code points.

The UE then determines a size of a second part of the second message based on the first part of the second message (3340). The UE then receives the second part of the second message (3350). For example, in 3350, the second part of the second message includes the N indicated TCI state code points. In various embodiments, the first part of the second message is received in a first channel and the second part of the second message is received in a second channel.

In various embodiments, the TCI states are in a set of L TCI states, where L is greater than 1, the first message includes a first part and a second part, the first part of the first message indicates the quantity K of the K activated TCI state code points, the second part of the first message indicates the K activated TCI state code points, and a TCI state code point corresponds to a TCI state from the set of L TCI states.

In various embodiments, the TCI states includes a first set of TCI states and a second set of TCI states, the first message includes a first part and a second part, the first part of the first message indicates quantities K1, K2, and K3. In this example, the second part of the first message indicates K1 activated TCI state code points, where each of the K1 activated TCI state code points corresponds to a TCI state from the first set of TCI states, K2 activated TCI state code points, where each of the K2 activated TCI state code points corresponds to a TCI state from the second set of TCI states, and K3 activated TCI state code points, where each of the K3 activated TCI state code points corresponds to a pair of TCI states, where one the pair of TCI states is from the first set of TCI states and the other of the pair of TCI states is from the second set of TCI states.

In various embodiments, the UE receives a configuration for RSs. Here, a RS from the RSs includes M>1 antenna ports. The configuration information for a TCI state from the TCI states indicates a RS ID corresponding to the RS and an antenna port ID indicating an antenna port from the M antenna ports.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive configuration information for transmission configuration indicator (TCI) states,
receive a first message activating K TCI state code points from the TCI states, where K≥1, and
receive a first part of a second message signaling a quantity (N) of indicated TCI state code points from the K activated TCI state code points, where N≥1; and
a processor operably coupled to the transceiver, the processor configured to determine a size of a second part of the second message based on the first part of the second message,
wherein the transceiver is further configured to receive the second part of the second message, and
wherein the second part of the second message includes the N indicated TCI state code points.

2. The UE of claim 1, wherein the N indicated TCI state code points are provided by a combinatorial index across the K activated TCI state code points.

3. The UE of claim 1, wherein:
the first part of the second message is received in a first channel, and
the second part of the second message is received in a second channel.

4. The UE of claim 1, wherein:
the TCI states are in a set of L TCI states, where L>1,
the first message includes a first part and a second part,
the first part of the first message indicates a quantity (K) of the K activated TCI state code points,
the second part of the first message indicates the K activated TCI state code points, and
a TCI state code point corresponds to a TCI state from the set of L TCI states.

5. The UE of claim 1, wherein:
the TCI states includes a first set of TCI states and a second set of TCI states,
the first message includes a first part and a second part,
the first part of the first message indicates quantities K1, K2, and K3, and
the second part of the first message indicates:
K1 activated TCI state code points, where each of the K1 activated TCI state code points corresponds to a TCI state from the first set of TCI states,
K2 activated TCI state code points, where each of the K2 activated TCI state code points corresponds to a TCI state from the second set of TCI states, and
K3 activated TCI state code points, where each of the K3 activated TCI state code points corresponds to a pair of TCI states, where one the pair of TCI states is from the first set of TCI states and the other of the pair of TCI states is from the second set of TCI states.

6. The UE of claim 1, wherein:
the transceiver is further configured to receive a configuration for reference signals (RSs),
a RS from the RSs includes M>1 antenna ports,
the configuration information for a TCI state from the TCI states indicates:
a RS identifier (ID) corresponding to the RS, and
an antenna port ID indicating an antenna port from the M antenna ports.

7. The UE of claim 1, wherein:
the first message includes a first part and a second part,
the first part of the first message and the first part of the second message are received in a first channel, and
the second part of the first message and the second part of the second message are received in a second channel.

8. A base station, comprising:
a transceiver configured to:
transmit configuration information for transmission configuration indicator (TCI) states, and
transmit a first message activating K TCI state code points, from the TCI states, where K≥1; and
a processor operably coupled to the transceiver, the processor configured to determine a quantity (N) of TCI state code points to indicate from the K activated TCI state code points, where N>1,
wherein the transceiver is further configured to:
transmit a first part of a second message signaling the quantity N, and
transmit a second part of the second message, and
wherein the second part of the second message includes the N indicated TCI state code points.

9. The BS of claim 8, wherein the N indicated TCI state code points are provided by a combinatorial index across the K activated TCI state code points.

10. The BS of claim 8, wherein:
the first part of the second message is transmitted in a first channel, and
the second part of the second message is transmitted in a second channel.

11. The BS of claim 8, wherein:
the configuration information for the TCI states are in a set of L TCI states, where L>1,
the first message includes a first part and a second part,
the first part of the first message indicates a quantity (K) of the K activated TCI state code points,
the second part of the first message indicates the K activated TCI state code points, and
a TCI state code point corresponds to a TCI state from the set of L TCI states.

12. The BS of claim 8, wherein:
the TCI states includes a first set of TCI states and a second set of TCI states,
the first message includes a first part and a second part,
the first part of the first message indicates quantities K1, K2 and K3, and
the second part of the first message indicates:
K1 activated TCI state code points, where each of the K1 activated TCI state code points corresponds to a TCI state from the first set of TCI states,
K2 activated TCI state code points, where each of the K2 activated TCI state code points corresponds to a TCI state from the second set of TCI states, and
K3 activated TCI state code points, where each of the K3 activated TCI state code points corresponds to a pair of TCI states, where one the pair of TCI states is from the first set of TCI states and the other of the pair of TCI states is from the second set of TCI states.

13. The BS of claim 8, wherein:
the transceiver is further configured to transmit a configuration for reference signals (RSs),
a RS from the RSs includes M>1 antenna ports,
the configuration information for a TCI state from the TCI states indicates:
a RS identifier (ID) corresponding to the RS, and
an antenna port ID indicating an antenna port from the M antenna ports.

14. The BS of claim 8, wherein:
the first message includes a first part and a second part,
the first part of the first message and the first part of the second message are transmitted in a first channel, and
the second part of the first message and the second part of the second message are transmitted in a second channel.

15. A method of operating a user equipment (UE), the method comprising:
receiving configuration information for transmission configuration indicator (TCI) states;
receiving a first message activating K TCI state code points from the configured TCI states, where K≥1;
receiving a first part of a second message signaling a quantity (N) of indicated TCI state code points from the K activated TCI state code points, where N≥1;
determining a size of a second part of the second message based on the first part of the second message; and
receiving the second part of the second message,
wherein the second part of the second message includes the N indicated TCI state code points.

16. The method of claim 15, wherein the N indicated TCI state code points are provided by a combinatorial index across the K activated TCI state code points.

17. The method of claim 15, wherein:
the first part of the second message is received in a first channel, and
the second part of the second message is received in a second channel.

18. The method of claim 15, wherein:
the TCI states are in a set of L TCI states, where L>1,
the first message includes a first part and a second part,
the first part of the first message indicates a quantity (K) of the K activated TCI state code points,
the second part of the first message indicates the K activated TCI state code points, and
a TCI state code point corresponds to a TCI state from the set of L TCI states.

19. The method of claim 15, wherein:
the TCI states include in a first set of TCI states and a second set of TCI states,
the first message includes a first part and a second part,
the first part of the first message indicates quantities K1, K2, and K3, and
the second part of the first message indicates:
K1 activated TCI state code points, where each of the K1 activated TCI state code points corresponds to a TCI state from the first set of TCI states,
K2 activated TCI state code points, where each of the K2 activated TCI state code points corresponds to a TCI state from the second set of TCI states, and
K3 activated TCI state code points, where each of the K3 activated TCI state code points corresponds to a pair of TCI states, where one the pair of TCI states is from the first set of TCI states and the other of the pair of TCI states is from the second set of TCI states.

20. The method of claim 15, further comprising:
receiving a configuration for reference signals (RSs),
wherein a RS from the RSs includes M>1 antenna ports, and
wherein the configuration information for a TCI state from the TCI states indicates:
a RS identifier (ID) corresponding to the RS, and
an antenna port ID indicating an antenna port from the M antenna ports.
